(19) United States
(12) Patent Application Publication
(10) Pub. No.: US 2026/0217924 A1
(43) Pub. Date: Jul. 30, 2026

(54) Crosslinkable Ethylene Polymer-Based Thermoplastic Vulcanizate and Molded Article Made from Same

(71) Applicant: Celanese International Corporation, Irving, TX (US)

(72) Inventors: Shinya Kawachi, Oyama, Tochigi (JP); Wanli Wang, Shanghai (CN); Jianya Cheng, Kingwood, TX (US)

(21) Appl. No.: 19/145,284

(22) PCT Filed: Jan. 6, 2023
(86) PCT No.: PCT/CN2023/070987

§ 371 Date: Jul. 2, 2025

(51) Int. Cl. C08J 3/24; C08J 3/20

(52) U.S. Cl. CPC C08J 3/246; C08J 3/20; C08J 3/244; C08J 2323/16; C08J 2423/08

(57) ABSTRACT

A molded article comprising a crosslinked thermoplastic vulcanizate comprising a crosslinked ethylene polymer and an at least partially cured elastomer is disclosed. Methods of making such a molded article are also disclosed. The present disclosure is also directed to a crosslinkable thermoplastic vulcanizate comprising a crosslinkable ethylene polymer and an at least partially cured elastomer.

### BACKGROUND OF THE INVENTION

Crosslinked polyethylene is generally one of the leading plastic materials used for a variety of applications. For instance, the thermo-mechanical properties of crosslinked polyethylene may enable it to be utilized for certain applications, such as for wires and cables, pipes, tubes, etc. To crosslink the polyethylene, certain crosslinking techniques are generally employed. In addition, crosslinked polyethylene may not be as flexible as desired for certain applications. As a result, there is a need to provide an ethylene polymer-based material with improved properties, in particular improved flexibility while maintaining mechanical properties, that can enable it to be utilized in certain applications.

### SUMMARY OF THE INVENTION

In accordance with one embodiment of the present disclosure, a molded article is disclosed. The molded article comprises a crosslinked thermoplastic vulcanizate comprising a crosslinked ethylene polymer and an at least partially cured elastomer.

In accordance with another embodiment of the present disclosure, a method of forming the molded article is disclosed. The method comprises: blending a crosslinking agent and a crosslinkable thermoplastic vulcanizate comprising a crosslinkable ethylene polymer and the at least partially cured elastomer to form a first blend; forming the first blend into a shape of the molded article; and crosslinking the crosslinkable ethylene polymer to provide the crosslinked ethylene polymer and the crosslinked thermoplastic vulcanizate.

In accordance with another embodiment of the present disclosure, a method of forming the molded article is disclosed. The method comprises: forming a crosslinkable thermoplastic vulcanizate comprising a crosslinkable ethylene polymer and the at least partially cured elastomer into a shape of the molded article; and crosslinking the crosslinkable ethylene polymer by exposure to irradiation to provide the crosslinked ethylene polymer and the crosslinked thermoplastic vulcanizate.

In accordance with another embodiment of the present disclosure, a method of forming the molded article is disclosed. The method comprises: providing a thermoplastic vulcanizate formulation comprising a crosslinkable ethylene polymer, an elastomer, a curing agent, and a crosslinking agent; dynamically vulcanizing the elastomer using the curing agent to form a crosslinkable thermoplastic vulcanizate; forming the crosslinkable thermoplastic vulcanizate into a shape of the molded article; and crosslinking the crosslinkable ethylene polymer to provide the crosslinked ethylene polymer and the crosslinked thermoplastic vulcanizate.

In accordance with another embodiment of the present disclosure, a method of forming the molded article is disclosed. The method comprises: providing a thermoplastic vulcanizate formulation comprising a crosslinkable ethylene polymer, an elastomer, and a curing agent; dynamically vulcanizing the elastomer using the curing agent to form a crosslinkable thermoplastic vulcanizate; forming the crosslinkable thermoplastic vulcanizate into a shape of the molded article; and crosslinking the crosslinkable ethylene polymer by exposure to irradiation to provide the crosslinked ethylene polymer and the crosslinked thermoplastic vulcanizate.

In accordance with another embodiment of the present disclosure, a crosslinkable thermoplastic vulcanizate is disclosed. The crosslinkable thermoplastic vulcanizate comprises a crosslinkable ethylene polymer and an at least partially cured elastomer. The crosslinkable ethylene polymer has at least 50 mol. % ethylene and from 0 to less than 20 mol. % propylene and is present in an amount of 15 wt. % or more to 60 wt. % or less based on the combined weight of the crosslinkable ethylene polymer and the at least partially cured elastomer. The crosslinkable thermoplastic vulcanizate comprises 5 wt. % or less to 0 wt. % of a propylene polymer based on the weight of the crosslinkable thermoplastic vulcanizate wherein the propylene polymer includes 60 mol. % or more of propylene units.

In accordance with another embodiment of the present disclosure, a crosslinked thermoplastic vulcanizate is disclosed. The crosslinked thermoplastic vulcanizate comprises a crosslinked ethylene polymer and an at least partially cured elastomer. The crosslinked ethylene polymer is formed from an ethylene polymer having at least 50 mol. % ethylene and from 0 to less than 20 mol. % propylene.

Other features and aspects of the present disclosure are set forth in greater detail below.

### BRIEF DESCRIPTION OF THE FIGURES

A full and enabling disclosure of the present disclosure, including the best mode thereof to one skilled in the art, is set forth more particularly in the remainder of the specification, including reference to the accompanying figures, in which:

FIG. 1 illustrates the results of a DMTA analysis of example 17;

FIG. 2 illustrates the results of a DMTA analysis example 18.

### DETAILED DESCRIPTION

It is to be understood by one of ordinary skill in the art that the present discussion is a description of exemplary embodiments only and is not intended as limiting the broader aspects of the present disclosure.

Generally speaking, the present disclosure is directed to utilizing a crosslinkable thermoplastic vulcanizate comprising a crosslinkable ethylene polymer and an at least partially cured elastomer dispersed within the crosslinkable ethylene polymer. In particular, such crosslinkable thermoplastic vulcanizate can be crosslinked to provide a crosslinked thermoplastic vulcanizate. For instance, such crosslinked thermoplastic vulcanizate may comprise a crosslinked ethylene polymer and an at least partially cured elastomer dispersed within the crosslinked ethylene polymer. Such crosslinkable thermoplastic vulcanizate and crosslinked thermoplastic vulcanizate can be utilized to form various molded articles.

The present inventors have discovered that utilizing such a material can exhibit a number of advantages, such as maintaining strength even with a crosslinked thermoplastic phase, thereby enabling it to be utilized in various applications. For instance, the thermoplastic vulcanizate may exhibit a particular Shore A hardness (ISO 868:2003; 15 seconds), which is utilized to measure the hardness of the thermoplastic vulcanizate and provide an indication of the resistance to indentation. In this regard, the thermoplastic vulcanizate may have a Shore A hardness of from 25 to 100. For instance, the thermoplastic vulcanizate may have a Shore A hardness of 25 or more, such as 30 or more, 35 or more, such as 40 or more, such as 45 or more, such as 50 or more, such as 55 or more, such as 60 or more, such as 65 or more. The thermoplastic vulcanizate may have a Shore A hardness of 100 or less, such as 95 or less, such as 90 or less, such as 80 or less, such as 70 or less, such as 65 or less, such as 60 or less, such as 55 or less, such as 50 or less, such as 45 or less. In one embodiment, the aforementioned Shore A hardness may apply to the crosslinkable thermoplastic vulcanizate as defined herein. In another embodiment, the aforementioned Shore A hardness may apply to the crosslinked thermoplastic vulcanizate as defined herein. Such hardness may allow for the thermoplastic vulcanizate to provide the compliance and flexibility to effectively function for a particular application.

In addition, the thermoplastic vulcanizate may exhibit a certain strength as indicated by certain mechanical properties. For instance, the thermoplastic vulcanizate may exhibit a 100% modulus (ASTM D412-16) of at least 0.3 MPa, such as from 0.5 to 5 MPa. For instance, the 100% modulus may be 0.3 MPa or more, such as 0.4 MPa or more, such as 0.5 MPa or more, such as 0.8 MPa or more, such as 1 MPa or more, such as 1.1 MPa or more, such as 1.2 MPa or more, such as 1.3 MPa or more, such as 1.4 MPa or more, such as 1.5 MPa or more, such as 2 MPa or more, such as 2.5 MPa or more, such as 3 MPa or more, such as 4 MPa or more, such as 5 Pa or more, such as 6 MPa or more, such as 10 MPa or more, such as 20 MPa or more, such as 30 MPa or more. The 100% modulus may be 50 MPa or less, such as 40 MPa or less, such as 30 MPa or less, such as 25 MPa or less, such as 20 MPa or less, such as 15 MPa or less, such as 10 MPa or less, such as 8 MPa or less, such as 6 Pa or less, such as 5 MPa or less, such as 4.5 MPa or less, such as 4 MPa or less, such as 3.8 MPa or less, such as 3.5 MPa or less, such as 3.3 MPa or less, such as 3 MPa or less, such as 2.8 MPa or less, such as 2.5 MPa or less, such as 2.3 MPa or less, such as 2 MPa or less, such as 1.9 MPa or less, such as 1.8 MPa or less, such as 1.5 MPa or less, such as 1.3 MPa or less, such as 1.1 MPa or less, such as 0.8 MPa or less. In one embodiment, the aforementioned 100% modulus may apply to the crosslinkable thermoplastic vulcanizate as defined herein. In another embodiment, the aforementioned 100% modulus may apply to the crosslinked thermoplastic vulcanizate as defined herein.

The thermoplastic vulcanizate may also exhibit a tensile stress at break (or ultimate tensile strength) of from 0.5 to 50 MPa, such as from 1 to 20 MPa, such as from 2 to 10 MPa. For instance, the thermoplastic vulcanizate may exhibit a tensile stress of 0.5 MPa or more, such as 1 MPa or more, such as 1.5 MPa or more, such as 2 MPa or more, such as 2.5 MPa or more, such as 3 MPa or more, such as 3.5 MPa or more, such as 4 MPa or more, such as 5 MPa or more, such as 6 MPa or more, such as 7 MPa or more, such as 10 MPa or more, such as 15 MPa or more, such as 20 MPa or more, such as 30 MPa or more, such as 40 MPa or more, such as 50 MPa or more, such as 60 MPa or more, such as 70 MPa or more. The tensile stress may be 100 MPa or less, such as 80 MPa or less, such as 60 MPa or less, such as 50 MPa or less, such as 40 MPa or less, such as 30 MPa or less, such as 25 MPa or less, such as 20 MPa or less, such as 18 MPa or less, such as 15 MPa or less, such as 13 MPa or less, such as 11 MPa or less, such as 10 MPa or less, such as 9 MPa or less, such as 8 MPa or less, such as 7 MPa or less, such as 6.5 MPa or less, such as 6 MPa or less, such as 5.5 MPa or less, such as 5 MPa or less, such as 4.5 MPa or less, such as 4 MPa or less, such as 3.5 MPa or less, such as 3 MPa or less, such as 2.5 MPa or less. The tensile stress may be determined in accordance with ASTM D412-16 at a temperature of 23° C., In one embodiment, the aforementioned tensile stress at break may apply to the crosslinkable thermoplastic vulcanizate as defined herein. In another embodiment, the aforementioned tensile stress at break may apply to the crosslinked thermoplastic vulcanizate as defined herein.

The thermoplastic vulcanizate may also exhibit a desired elongation at break (or ultimate elongation). For instance, the elongation at break may be 20% or more, such as 40% or more, such as 60% or more, such as 80% or more, such as 100% or more, such as 200% or more, such as 300% or more, such as 400% or more, such as 500% or more, such as 550% or more, such as 600% or more, such as 650% or more, such as 700% or more, such as 750% or more, such as 900% or more, such as 1000% or more, such as 1200% or more, such as 1400% or more, such as 1600% or more. The elongation at break may be 2000% or less, such as 1800% or less, such as 1600% or less, such as 1500% or less, such as 1300% or less, such as 1000% or less, such as 900% or less, such as 800% or less, such as 700% or less, such as 600% or less, such as 500% or less, such as 450% or less, such as 400% or less, such as 350% or less, such as 300% or less, such as 200% or less, such as 100% or less, such as 80% or less, such as 60% or less. The elongation at break may be determined in accordance with ASTM D412-16 at a temperature of 23° C. In one embodiment, the aforementioned elongation at break may apply to the crosslinkable thermoplastic vulcanizate as defined herein. In another embodiment, the aforementioned elongation at break may apply to the crosslinked thermoplastic vulcanizate as defined herein.

The thermoplastic vulcanizate may also exhibit a desired tension set. For instance, the tension set may be 3% or more, such as 4% or more, such as 5% or more., such as 6% or more, such as 7% or more, such as 8% or more, such as 9% or more, such as 10% or more, such as 11% or more, such as 12% or more, such as 13% or more, such as 15% or more. The tension set may be 30% or less, such as 28% or less, such as 25% or less, such as 23% or less, such as 20% or less, such as 18% or less, such as 15% or less, such as 13% or less, such as 10% or less, such as 8% or less. The tension set may be determined in accordance with ISO 2285:2019. In one embodiment, the aforementioned tension set may apply to the crosslinkable thermoplastic vulcanizate as defined herein. In another embodiment, the aforementioned tension set may apply to the crosslinked thermoplastic vulcanizate as defined herein.

Various embodiments of the present disclosure will now be described in more detail.

### I. Thermoplastic Vulcanizate

As indicated above, the thermoplastic vulcanizate contains an ethylene polymer and an at least partially cured elastomer. In this regard, the thermoplastic vulcanizate in one embodiment may be a crosslinkable thermoplastic vulcanizate. As defined herein, such crosslinkable thermoplastic vulcanizate comprises a crosslinkable ethylene polymer and an at least partially cured elastomer, in particular dispersed within the crosslinkable ethylene polymer. Accordingly, as defined herein, such crosslinkable ethylene polymer has not yet undergone a crosslinking step. In other words, such crosslinkable ethylene polymer may be an uncrosslinked ethylene polymer. Upon crosslinking, the crosslinkable thermoplastic vulcanizate will be converted to a crosslinked thermoplastic vulcanizate due to the crosslinkable ethylene polymer having been converted to a crosslinked ethylene polymer. In this regard, the crosslinked thermoplastic vulcanizate may comprise the crosslinked ethylene polymer and the at least partially cured elastomer, in particular dispersed within the crosslinked ethylene polymer.

### A. Ethylene Polymer

As indicated above, the thermoplastic vulcanizate contains one or more ethylene polymers. In one embodiment, one ethylene polymer may be utilized within the thermoplastic vulcanizate. In other embodiments, the thermoplastic vulcanizate may include a mixture of ethylene polymers. For instance, more than one ethylene polymer, such as two or three ethylene polymers, may be utilized in the thermoplastic vulcanizate. Furthermore, the ethylene polymer may be a homopolymer or a copolymer. In one embodiment, the ethylene polymer may be a homopolymer (i.e., polyethylene homopolymer). In another embodiment, the ethylene polymer may be a copolymer (i.e., polyethylene copolymer). In a further embodiment, the ethylene polymer may include a mixture of a homopolymer and a copolymer.

In this regard, the ethylene polymer as a homopolymer may be formed by polymerizing ethylene. When the ethylene polymer is a copolymer, the copolymer may be formed by polymerizing ethylene and one or more alpha-olefins, such as one or more C₃-C₂₀ alpha-olefins, such as one or more C₃-C₁₂ alpha-olefins, such as one or more C₃-C₈ alpha-olefins. These alpha-olefins may include, but are not limited to, propylene, 1-butene, 1-hexene, 1-octene, 2-methyl-1-propene, 3-methyl-1-pentene, 4-methyl-1-pentene, 5-methyl-1-hexene, and mixtures thereof. In particular, the alpha-olefin may be propylene, 1-butene, 1-hexene, 1-octene, or a mixture thereof. In one embodiment, the additional monomer may comprise propylene. In another embodiment, the additional monomer may comprise 1-butene. In a further embodiment, the additional monomer may comprise 1-hexene. In an even further embodiment, the additional monomer may comprise 1-octene. Furthermore, the additional comonomer may be linear or branched.

In this regard, the ethylene polymer may be a copolymer formed from ethylene and propylene in one embodiment. In another embodiment, the ethylene polymer may be a copolymer formed from ethylene and a C₄-C₂₀ alpha-olefin, such as a C₄-C₁₂ alpha-olefin, such as a C₄-C₈ alpha-olefin. For instance, the alpha-olefin may include, but is not limited to, 1-butene, 1-hexene, 1-octene, 2-methyl-1-propene, 3-methyl-1-pentene, 4-methyl-1-pentene, 5-methyl-1-hexene or mixtures thereof. In this regard, the alpha-olefin may include 1-butene, 1-hexene, 1-octene, or a mixture thereof. In one embodiment, the ethylene polymer may be a copolymer formed from ethylene and at least one of 1-hexene and/or 1-butene. As one example, the ethylene polymer may be a copolymer formed from ethylene and 1-hexene. In another embodiment, the ethylene polymer may be a copolymer formed from ethylene and 1-butene. In a further embodiment, the ethylene polymer may be a copolymer formed from ethylene, propylene, and a C₄-C₈ alpha-olefin, such as 1-butene, 1-hexene, 1-octene, 2-methyl-1-propene, 3-methyl-1-pentene, 4-methyl-1-pentene, 5-methyl-1-hexene or mixtures thereof.

The ethylene copolymer may also be formed by polymerizing ethylene with a monomer other than an alpha-olefin. For example, in one embodiment, the ethylene copolymer may be formed from ethylene and styrene to provide a styrene-ethylene copolymer. In another embodiment, the ethylene copolymer may be formed from ethylene and one or more α,β-unsaturated acids and/or one or more α,β-unsaturated esters. An example of such an ethylene copolymer may include a polyethylene-acrylate copolymer. In this regard, suitable comonomers can include polar vinyl monomers such as acrylic acid and/or its salts (e.g., inorganic such as sodium, potassium, lithium, calcium, magnesium, aluminum, copper, nickel, iron, and the like; organic such as ammonium, mono-, di-, tri-, or tetra-alkylammonium, and the like; or a combination thereof), alkacrylic acids (e.g., methacrylic acid, ethacrylic acid, and the like) and/or its salts, alkyl acrylates (e.g., methyl acrylate, ethyl acrylate, n-propyl acrylate, isopropyl acrylate, n-butyl acrylate, isobutyl acrylate, and the like), alkacrylates (e.g., methacrylate, ethacrylate, and the like), alkyl alkacrylates (e.g., methyl methacrylate, ethyl methacrylate, methyl isobutylacrylate, and the like), vinyl acetate, anhydrides (e.g., maleic anhydride, crotonic anhydride, and the like), and the like, and combinations thereof.

Regardless, when the ethylene polymer is a copolymer, it should be understood that the primary monomer is ethylene. Accordingly, the ethylene content of the polymer may be more than 50 mol. %, such as 55 mol. % or more, such as 60 mol. % or more, such as 65 mol. % or more, such as 70 mol. % or more, such as 75 mol. % or more, such as 80 mol. % or more, such as 85 mol. % or more, such as 90 mol. % or more, such as 95 mol. % or more to less than 100 mol. %, such as 99 mol. % or less, such as 98 mol. % or less, such as 97 mol. % or less, such as 96 mol. % or less, such as 95 mol. % or less. Meanwhile, the comonomer, such as the C₃-C₂₀ alpha-olefin, may be present in an amount of less than 50 mol. %, such as 40 mol. % or less, such as 30 mol. % or less, such as 25 mol. % or less, such as 20 mol. % or less, such as 15 mol. % or less, such as 10 mol. % or less, such as 5 mol. % or less to more than 0 mol. %, such as 1 mol. % or more, such as 2 mol. % or more, such as 3 mol. % or more, such as 4 mol. % or more, such as 5 mol. % or more. Particularly, the propylene content of the polymer may be 20 mol. % or less, such as 15 mol. % or less, such as 10 mol. % or less, such as 5 mol. % or less, such as 3 mol. % or less, such as 2 mol. % or less, such as 1 mol. % or less, such as about 0 mol. %. The propylene content may be 0 mol. % or more, such as 0.01 mol. % or more, such as 0.05 mol. % or more, such as 0.1 mol. % or more. In one particular embodiment, the ethylene polymer may not be formed from any propylene.

In addition to the above, in one embodiment, the ethylene polymer may have a particular density. For instance, the density may be from about 0.80 g/cm³ to about 1 g/cm³, such as from about 0.84 g/cm³ to about 0.99 g/cm³, such as from about 0.84 g/cm³ to about 0.94 g/cm³, such as from about 0.85 g/cm³ to about 0.94 g/cm³, such as from about 0.91 g/cm³ to about 0.94 g/cm³. In this regard, the ethylene polymer may be a linear low density polyethylene (LLDPE), a low density polyethylene (LDPE), a medium density polyethylene (MDPE), a high density polyethylene (HDPE), or a mixture thereof. Such polyethylenes may have a particular density as determined in accordance with ASTM D792. For instance, a linear low density polyethylene (LLDPE) may have a density in the range of from about 0.91 g/cm³ to about 0.94 g/cm³. Meanwhile, a low density polyethylene (LDPE) may have a density in the range of from about 0.91 g/cm³ to about 0.925 g/cm³. A medium density polyethylene (MDPE) may have a density in the range of from about 0.926 g/cm³ to about 0.94 g/cm³. Also, a high density polyethylene (HDPE) may have density in the range of from about 0.941 g/cm³ to about 0.965 g/cm³. In one embodiment, the ethylene polymer may be a low density polyethylene. In another embodiment, the ethylene polymer may be a linear low density polyethylene. In a further embodiment, the ethylene polymer may be a medium density polyethylene.

In one embodiment, the ethylene polymer may be a low density polyethylene copolymer formed from ethylene and 1-butene. In another embodiment, the ethylene polymer may be linear low density polyethylene copolymer formed from ethylene and 1-butene. In a further embodiment, the ethylene polymer may be a medium density polyethylene copolymer formed from ethylene and 1-butene.

In one embodiment, the ethylene polymer may be low density polyethylene copolymer formed from ethylene and 1-hexene. In another further embodiment, the ethylene polymer may be linear low density polyethylene copolymer formed from ethylene and 1-hexene. In a further embodiment, the ethylene polymer may be a medium density polyethylene copolymer formed from ethylene and 1-hexene.

In one embodiment, the ethylene polymer may also include a functionalized ethylene polymer. The functionalized ethylene polymer in one embodiment may be present as the primary ethylene polymer. In another embodiment, the functionalized ethylene polymer may be present as a secondary ethylene polymer, for instance in an amount less than another ethylene polymer within the thermoplastic vulcanizate.

The functionalized ethylene polymer may include a polymer including at least one functional group. The functional group, which may also be referred to as a functional substituent or functional moiety, includes a hetero atom. In one or more embodiments, the functional group includes a polar group. Examples of polar groups include hydroxy, carbonyl, ether, halide, amine, imine, nitrile, silyl, epoxide, or isocyanate groups. Exemplary groups containing a carbonyl moiety include carboxylic acid, anhydride, ketone, acid halide, ester, amide, or imide groups, and derivatives thereof. In one embodiment, the functional group includes a succinic anhydride group, or the corresponding acid, which may derive from a reaction (e.g., polymerization or grafting reaction) with maleic anhydride, or a β-alkyl substituted propanoic acid group or derivative thereof.

In general, the ethylene polymer can include a solid, generally high molecular weight polymeric material. The ethylene polymer may have a Mw of about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more, such as 2,000,000 g/mol or more, such as 3,000,000 g/mol or more. The Mw may be about 6,000,000 g/mol or less, such as about 5,000,000 g/mol or less, such as 4,000,000 g/mol or less, such as 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less. Furthermore, the ethylene polymer may have a Mn of about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more, such as 2,000,000 g/mol or more, such as 3,000,000 g/mol or more. The Mn may be about 6,000,000 g/mol or less, such as about 5,000,000 g/mol or less, such as 4,000,000 g/mol or less, such as 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less. In general, the molecular weight may be characterized by GPC (gel permeation chromatography) using polystyrene standards.

The ethylene polymer may be a crystalline polymer in one embodiment or a semi-crystalline polymer in another embodiment. For instance, the crystallinity may be at least 25%, such as at least 35%, such as at least 45%, such as at least 55%, such as at least 65%, such as at least 70%, such as at least 75%, such as at least 80%, such as at least 85%, such as at least 90%, such as at least 95% by weight. The crystallinity may be about 100% in one embodiment. The crystallinity may be determined by differential scanning calorimetry. For instance, crystallinity may be determined by dividing the heat of fusion of a sample by the heat of fusion of a 100% crystalline polymer.

The ethylene polymer may also have a particular glass transition temperature (“Tg”). In this regard, the Tg may be about −130° C. or more, such as 120° C. or more, such as −110° C. or more, such as −100° C. or more, such as −90° C. or more, such as −70° C. or more, such as −50° C. or more, such as −30° C. or more, such as −25° C. or more, such as −20° C. or more, such as −15° C. or more, such as −10° C. or more, such as −5° C. or more, such as 0° C. or more, such as 5° C. or more, such as 10° C. or more, such as 20° C. or more, such as 30° C. or more, such as 50° C. or more, such as 80° C. or more. The Tg may be about 150° C. or less, such as 100° C. or less, such as 80° C. or less, such as 60° C. or less, such as 40° C. or less, such as 30° C. or less, such as 20° C. or less, such as 10° C. or less, such as 5° C. or less, such as 0° C. or less, such as −5° C. or less, such as −10° C. or less, such as −20° C. or less, such as −30° C. or less, such as −40° C. or less, such as −50° C. or less, such as −60° C. or less, such as −70° C. or less, such as −80° C. or less, such as −90° C. or less, such as −100° C. or less.

In addition, the ethylene polymer may have a particular melt temperature (“Tm”). For instance, the melt temperature of the ethylene polymer may be relatively high. Furthermore, the melt temperature of the ethylene polymer may be lower than the decomposition temperature of the elastomer in the thermoplastic vulcanizate, such decomposition temperature generally characterized as when the molecular bonds begin to break or scission such that the molecular weight of the elastomer begins to decrease. In this regard, the Tm may be about 30° C. or more, such as 40° C. or more, such as 50° C. or more, such as 60° C. or more, such as 70° C. or more, such as 80° C. or more, such as 9° C. or more, such as 100° C. or more, such as 110° C. or more, such as 120° C. or more, such as 130° C. or more, such as 140° C. or more, such as 150° C. or more. The Tm may be 250° C. or less, such as 20000 or less, such as 180° C. or less, such as 160° C. or less, such as 150° C. or less, such as 140° C. or less, such as 130° C. or less, such as 120° C. or less, such as 110° C. or less. The melting temperature may be determined via DSC.

The ethylene polymer may also be characterized as having a particular heat of fusion. For instance, the heat of fusion may be about 0.1 J/g or more, such as about 1 J/g or more, such as about 2 J/g or more, such as about 5 J/g or more, such as about 10 J/g or more, such as about 10 J/g or more, such as about 30 J/g or more, such as 40 J/g or more, such as 50 J/g or more, such as 60 J/g or more, such as 70 J/g or more, such as 100 J/g or more, such as 120 J/g or more, such as 140 J/g or more, such as 160 J/g or more, such as 180 J/g or more, such as 200 J/g or more. The heat of fusion may be about 300 J/g or less, such as about 260 J/g or less, such as about 240 J/g or less, such as about 200 J/g or less, such as about 180 J/g or less, such as about 150 J/g or less, such as about 120 J/g or less, such as about 100 J/g or less, such as about 80 J/g or less, such as about 60 J/g or less, such as about 50 J/g or less, such as about 40 J/g or less, such as about 30 J/g or less, such as about 20 J/g or less. The heat of fusion may be determined via DSC.

The ethylene polymer may have a melt flow rate of up to 400 g/10 min. In general, the ethylene polymer may have better properties where the melt flow rate is less than about 30 g/10 min., preferably less than 10 g/10 min, such as less than about 2 g/10 min, such as less than about 1 g/10 min, such as less than about 0.8 g/10 min. In general, the melt flow rate may be 0.1 g/10 min or more, such as 0.2 g/10 min or more, such as 0.3 g/10 min or more, such as 0.4 g/10 min or more, such as 0.5 g/10 min or more. Melt flow rate is a measure of how easily a polymer flows under standard pressure and is measured by using ASTM D-1238 at 190° C. and 2.16 kg load.

The ethylene polymer may also have a particular modulus of elasticity. For example, the modulus of elasticity may be 50 MPa or more, such as 100 MPa or more, such as 200 MPa or more, such as 300 MPa or more, such as 400 MPa or more, such as 500 MPa or more, such as 700 MPa or more, such as 1,000 MPa or more, such as 1,500 MPa or more, such as 2,000 MPa or more, such as 3,000 MPa or more. The modulus of elasticity may be 5,000 MPa or less, such as 4,500 MPa or less, such as 4,000 MPa or less, such as 3,500 MPa or less, such as 3,000 MPa or less, such as 2,500 MPa or less, such as 2,000 MPa or less, such as 1,500 MPa or less, such as 1,300 MPa or less, such as 1,000 MPa or less, such as 900 MPa or less, such as 800 MPa or less, such as 700 MPa or less, such as 600 MPa or less, such as 500 MPa or less, such as 400 MPa or less, such as 300 MPa or less, such as 200 MPa or less. The modulus of elasticity may be determined in accordance with ASTM D638-10.

The ethylene polymer may also have a particular 1% secant flexural modulus. For instance, the 1% secant flexural modulus may be 50 MPa or more, such as 100 MPa or more, such as 150 MPa or more, such as 200 MPa or more, such as 300 MPa or more, such as 400 MPa or more, such as 500 MPa or more. The 1% secant flexural modulus may be 1,500 MPa or less, such as 1,300 MPa or less, such as 1,000 MPa or less, such as 900 MPa or less, such as 800 MPa or less, such as 700 MPa or less, such as 600 MPa or less, such as 500 MPa or less, such as 400 MPa or less, such as 300 MPa or less, such as 200 MPa or less. The 1% secant flexural modulus may be determined in accordance with ASTM D882-18.

The ethylene polymer may also have a particular tensile strength at break. For instance, the ethylene polymer may exhibit a tensile strength at break of 1 MPa or more, such as 2 MPa or more, such as 3 MPa or more, such as 5 MPa or more, such as 10 MPa or more, such as 15 MPa or more, such as 20 MPa or more, such as 25 MPa or more, such as 30 MPa or more, such as 35 MPa or more, such as 40 MPa or more, such as 45 MPa or more. The tensile strength at break may be 150 MPa or less, such as 120 MPa or less, such as 100 MPa or less, such as 90 MPa or less, such as 80 MPa or less, such as 70 MPa or less, such as 60 MPa or less, such as 50 MPa or less, such as 40 MPa or less. The tensile strength at break may be determined in accordance with ASTM D882-18.

The ethylene polymer may also exhibit a desired elongation at break (or ultimate elongation). For instance, the elongation at break may be 100% or more, such as 200% or more, such as 300% or more, such as 400% or more, such as 500% or more, such as 550% or more, such as 600% or more, such as 650% or more, such as 700% or more, such as 750% or more. The ethylene polymer may be 1500% or less, such as 1300% or less, such as 1000% or less, such as 900% or less, such as 800% or less, such as 700% or less, such as 600% or less, such as 500% or less, such as 450% or less, such as 400% or less, such as 350% or less, such as 300% or less. The elongation at break may be determined in accordance with ASTM D882-18.

The thermoplastic vulcanizate can generally comprise about 5 wt. % or more, such as about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 50 wt. % or more, such as about 60 wt. % or more of the ethylene polymer. The thermoplastic vulcanizate may comprise about 90 wt. % or less, such as about 80 wt. % or less, such as about 70 wt. % or less, such as about 60 wt. % or less, such as about 50 wt. % or less, such as about 40 wt. % or less, such as about 30 wt. % or less, such as about 20 wt. % or less, such as about 15 wt. % or less of the ethylene polymer. In one embodiment, such weight percentages may be based on the weight of the thermoplastic vulcanizate. In another embodiment, such aforementioned weight percentages may be based on the combined weight of the ethylene polymer and the elastomer combined. Furthermore, the aforementioned thermoplastic vulcanizate may be in reference to the crosslinkable thermoplastic vulcanizate in one embodiment. In another embodiment, the aforementioned thermoplastic vulcanizate may be in reference to the crosslinked thermoplastic vulcanizate.

Stated in another manner, the ethylene polymer may be present in an amount of 10 phr or more, such as 15 phr or more, such as 20 phr or more, such as 25 phr or more, such as 30 phr or more, such as 40 phr or more, such as 50 phr or more, such as 60 phr or more, such as 70 phr or more, such as 80 phr or more. The ethylene polymer may be present in an amount of 200 phr or less, such as 150 phr or less, such as 120 phr or less, such as 100 phr or less, such as 90 phr or less, such as 80 phr or less, such as 70 phr or less, such as 60 phr or less, such as 50 phr or less, such as 40 phr or less, such as 30 phr or less. Such content of ethylene polymer may be in reference to the crosslinkable ethylene polymer in the crosslinkable thermoplastic vulcanizate in one embodiment. In another embodiment, such content of ethylene polymer may be in reference to the crosslinked ethylene polymer in the crosslinked thermoplastic vulcanizate.

Furthermore, the thermoplastic vulcanizate may comprise 20 wt. % or less, such as 15 wt. % or less, such as 10 wt. % or less, such as 5 wt. % or less, such as 4 wt. % or less, such as 3 wt. % or less, such as 2 wt. % or less, such as 1 wt. % or less, such as 0.5 wt. % or less, such as about 0 wt. % of a thermoplastic resin that is a propylene polymer. The propylene polymer may be present in an amount of 0 wt. % or more. In one embodiment, the propylene polymer may be present in an amount of about 0 wt. %. For the sake of clarity, such propylene polymer generally considered a thermoplastic shall be distinguished from any elastomer component defined herein comprising a propylene monomer. Such amount of propylene polymer may be in reference to the crosslinkable thermoplastic vulcanizate and/or crosslinked thermoplastic vulcanizate. For instance, such propylene polymer may be a thermoplastic including 50 mol. % or more, such as 60 mol % or more, such as 70 mol. % or more, such as 80 mol. % or more, such as 85 mol. % or more, such as 90 mol. % or more, such as 95 mol. % or more of propylene units.

Furthermore, the method of making the ethylene polymer as utilized herein is not limited. For instance, the ethylene polymer may be synthesized using any polymerization technique known in the art such as, but not limited to, the Phillips catalyzed reactions, conventional Ziegler-Natta type polymerizations, and metallocene catalysis including, but not limited to, metallocene-alumoxane and metallocene-ionic activator catalysis. Suitable catalyst systems thus include chiral metallocene catalyst systems, see, e.g., U.S. Pat. No. 5,441,920, and transition metal-centered, heteroaryl ligand catalyst systems, see, e.g., U.S. Pat. No. 6,960,635.

### B. Elastomer

As indicated above, the thermoplastic vulcanizate contains an elastomer. In general, any elastomer suitable for use in the manufacture of TPVs can be utilized in accordance with the present disclosure. In one embodiment, one elastomer may be utilized as the elastomer. In other embodiments, the elastomer may include a mixture of elastomers. For instance, more than one elastomer, such as two or three elastomers, may be utilized in the thermoplastic vulcanizate.

Any elastomer or mixture thereof that is capable of being vulcanized (that is crosslinked or cured) can be used as the elastomer (also referred to herein sometimes as the rubber). Reference to a rubber or elastomer may include mixtures of more than one. Some non-limiting examples of these rubbers include polyolefin copolymer elastomers, butyl rubber, natural rubber, styrene-butadiene copolymer rubber (e.g., styrene/ethylene-butadiene/styrene), butadiene rubber, acrylonitrile rubber, halogenated rubber such as brominated and chlorinated isobutylene-isoprene copolymer rubber, butadiene-styrene-vinyl pyridine rubber, urethane rubber, polyisoprene rubber, epichlolorohydrin terpolymer rubber, and polychloroprene.

Vulcanizable elastomers includes polyolefin copolymer elastomers. These copolymers are made from one or more of ethylene and higher alpha-olefins, which may include, but are not limited to propylene, 1-butene, 1-hexene, 4-methyl-1 pentene, 1-octene, 1-decene, or combinations thereof. An example of such a copolymer elastomer may include an ethylene propylene rubber. Furthermore, in addition to the ethylene and the higher alpha-olefin, the elastomer may also contain one or more copolymerizable, multiply unsaturated comonomers, such as diolefins, or diene monomers. The alpha-olefins can be propylene, 1-hexene, 1-octene, or combinations thereof. These rubbers may lack substantial crystallinity and can be suitably amorphous copolymers.

The diene monomers may include, but are not limited to, 5-ethylidene-2-norbornene; 1,4-hexadiene; 5-methylene-2-norbornene; 1,6-octadiene; 5-methyl-1,4-hexadiene: 3,7-dimethyl-1,6-octadiene; 1,3-cyclopentadiene; 1,4-cyclohexadiene; dicyclopentadiene; 5-vinyl-2-norbornene, divinyl benzene, and the like, or a combination thereof. The diene monomers can be 5-ethylidene-2-norbornene and/or 5-vinyl-2-norbornene. If the copolymer is prepared from ethylene, alpha-olefin, and diene monomers, the copolymer may be referred to as a terpolymer (EPDM rubber), or a tetrapolymer in the event that multiple alpha-olefins or dienes, or both, are used (EAODM rubber).

Elastomers that are polyolefin elastomer copolymers can contain from about 15 to about 90 mole percent ethylene units deriving from ethylene monomer, from about 40 to about 85 mole percent, or from about 50 to about 80 mole percent ethylene units. The copolymer may contain from about 10 to about 85 mole percent, or from about 15 to about 50 mole percent, or from about 20 to about 40 mole percent, alpha-olefin units deriving from alpha-olefin monomers. The foregoing mole percentages are based upon the total moles of the mer units of the polymer. Where the copolymer contains diene units, the copolymers may contain from 0.1 to about 14 weight percent, from about 0.2 to about 13 weight percent, or from about 1 to about 12 weight percent units deriving from diene monomer. The weight percent diene units deriving from diene may be determined according to ASTM D-6047. In some occurrences, the copolymers contain less than 5.5 weight percent, such as less than 5.0 weight percent, such as less than 4.5 weight percent, such as less than 4.0 weight percent units deriving from diene monomer. In yet other cases, the copolymers contain greater than 6.0 weight percent, such as greater than 6.2 weight percent, such as greater than 6.5 weight percent, such as greater than 7.0 weight percent units, such as greater than 8.0 weight percent deriving from diene monomer.

The polyolefin elastomer copolymer may be obtained using polymerization techniques known in the art such as traditional solution or slurry polymerization processes. For instance, the catalyst employed to polymerize the ethylene, alpha-olefin, and diene monomers into elastomeric copolymers can include both traditional Ziegler-Natta type catalyst systems, especially those including titanium and vanadium compounds, as well as metallocene catalysts for Group 3-6 (titanium, zirconium and hafnium) metallocene catalysts, particularly the bridged mono- or biscyclopentadienyl metallocene catalysts. Other catalyst systems such as Brookhart catalyst systems may also be employed.

In one embodiment, the elastomer may include a butyl rubber. For instance, the butyl rubber includes copolymers and terpolymers of isobutylene and at least one other comonomer. Useful comonomers include isoprene, divinyl aromatic monomers, alkyl substituted vinyl aromatic monomers, and mixtures thereof. Exemplary divinyl aromatic monomers include vinyl styrene. Exemplary alkyl substituted vinyl aromatic monomers include α-methyl styrene and paramethyl styrene. These copolymers and terpolymers may also be halogenated such as in the case of chlorinated and brominated butyl rubber. In one or more embodiments, these halogenated polymers may derive from monomers such as parabromomethylstyrene.

In one or more embodiments, the butyl rubber includes copolymers of isobutylene and isoprene, copolymers of isobutylene and paramethyl styrene, terpolymers of isobutylene, isoprene, and divinyl styrene, branched butyl rubber, and brominated copolymers of isobutene and paramethylstyrene (yielding copolymers with parabromomethylstyrenyl mer units). These copolymers and terpolymers may be halogenated. Furthermore, butyl rubbers may be prepared by polymerization, using techniques known in the art such as at a low temperature in the presence of a Friedel-Crafts catalyst.

In one embodiment, where the butyl rubber includes the isobutylene-isoprene copolymer, the copolymer may include from about 0.5 to about 30, or from about 0.8 to about 5, percent by weight isoprene based on the entire weight of the copolymer with the remainder being isobutylene.

In another embodiment, where the butyl rubber includes isobutylene-paramethyl styrene copolymer, the copolymer may include from about 0.5 to about 25, and from about 2 to about 20, percent by weight paramethyl styrene based on the entire weight of the copolymer with the remainder being isobutylene. In one embodiment, isobutylene-paramethyl styrene copolymers can be halogenated, such as with bromine, and these halogenated copolymers can contain from about 0 to about 10 percent by weight, or from about 0.3 to about 7 percent by weight halogenation.

In other embodiments, where the butyl rubber includes isobutylene-isoprene-divinyl styrene, the terpolymer may include from about 95 to about 99, or from about 96 to about 98.5, percent by weight isobutylene, and from about 0.5 to about 5, or from about 0.8 to about 2.5, percent by weight isoprene based on the entire weight of the terpolymer, with the balance being divinyl styrene.

In the case of halogenated butyl rubbers, the butyl rubber may include from about 0.1 to about 10, or from about 0.3 to about 7, or from about 0.5 to about 3 percent by weight halogen based upon the entire weight of the copolymer or terpolymer.

In one or more embodiments, the glass transition temperature (Tg) of the butyl rubber can be less than about −55° C., or less than about −58° C., or less than about −60° C., or less than about −63° C. Also, the Mooney viscosity (ML₁₊₈@125° C.) of the butyl rubber can be from about 25 to about 75, or from about 30 to about 60, or from about 40 to about 55.

In general, the elastomer, in particular the polyolefin elastomer copolymer, may have a Mw of about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more. The Mw may be about 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less, such as 600,000 g/mol or less, such as 500,000 g/mol or less, such as 400,000 g/mol or less, such as 300,000 g/mol or less. Furthermore, the elastomer, in particular the polyolefin elastomer copolymer, may have a Mn of about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more. The Mn may be about 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less, such as 600,000 g/mol or less, such as 500,000 g/mol or less, such as 400,000 g/mol or less, such as 300,000 g/mol or less. In general, the molecular weight may be characterized by GPC (gel permeation chromatography) using polystyrene standards.

The thermoplastic vulcanizate can generally comprise about 2 wt. % or more, such as about 5 wt. % or more, such as about 10 wt. % or more, such as about 15 wt. % or more, such as about 20 wt. % or more, such as about 25 wt. % or more, such as about 30 wt. % or more, such as about 40 wt. % or more, such as about 50 wt. % or more of the elastomer. The thermoplastic vulcanizate may comprise about 90 wt. % or less, such as about 80 wt. % or less, such as about 70 wt. % or less, such as about 60 wt. % or less, such as about 50 wt. % or less, such as about 40 wt. % or less, such as about 35 wt. % or less, such as about 30 wt. % or less, such as about 25 wt. % or less, such as about 20 wt. % or less, such as about 15 wt. % or less of the elastomer. In another embodiment, such aforementioned weight percentages may be based on the combined weight of the ethylene polymer and the elastomer combined in the thermoplastic vulcanizate.

Furthermore, when a mixture of elastomers is present, the primary elastomer may be present in an amount of about 60 wt. % or more, such as about 70 wt. % or more, such as about 80 wt. % or more, such as about 90 wt. % or more to less than 100 wt. % based on the weight of the elastomer. The secondary elastomer may be present in an amount of 40 wt. % or less, such as 30 wt. % or less, such as 20 wt. % or less, such as 15 wt. % or less, such as 10 wt. % or less, such as 5 wt. % or more to more than 0 wt. % of the elastomer.

### C. Curing Composition

As indicated herein, the TPV formulation, in particular the elastomer within the formulation, may undergo dynamic vulcanization wherein the elastomer is at least partially cured. In general, any curing agent that is capable of curing or crosslinking the elastomer may be used. Some non-limiting examples of these curing agents include phenolic resins, peroxides, maleimides, and silicon-containing curing agents. In one particular embodiment, the curing agents may include phenolic resins, maleimides, and/or silicon-containing curing agents. In a further embodiment, the curing agents may include phenolic resins and/or silicon-containing curing agents. In this regard, in one embodiment, the vulcanization may be conducted without using any peroxides. For instance, this may allow for dynamic vulcanization of the rubber without crosslinking of the ethylene polymer.

The curing agents may be used with one or more coagents that serve as initiators, catalysts, etc. for purposes of improving the overall cure state of the elastomer. For instance, the curing composition of some embodiments includes one or both of zinc oxide (ZnO) and stannous chloride (SnCl₂).

In general, the phenolic resins may not necessarily be limited. For instance, these may include resole resins made by the condensation of alkyl substituted phenols or unsubstituted phenols with aldehydes, which can be formaldehydes, in an alkaline medium or by condensation of bi-functional phenoldialcohols. The alkyl substituents of the alkyl substituted phenols typically contain 1 to about 10 carbon atoms. Dimethylol phenols or phenolic resins, substituted in para-positions with alkyl groups containing 1 to about 10 carbon atoms can be used. These phenolic curing agents may be thermosetting resins and may be referred to as phenolic resin curing agents or phenolic resins. These phenolic resins may be ideally used in conjunction with a catalyst system. For example, non-halogenated phenol curing resins are used in conjunction with halogen donors and, optionally, a hydrogen halide scavenger. Where the phenolic curing resin is halogenated, a halogen donor is not required but the use of a hydrogen halide scavenger, such as ZnO, can be used.

Peroxide curing agents are generally selected from organic peroxides. Examples of organic peroxides include, but are not limited to, di-tert-butyl peroxide, dicumyl peroxide, t-butylcumyl peroxide, alpha,alpha-bis(tert-butylperoxy)diisopropyl benzene, 2,5 dimethyl 2,5-di(t-butylperoxy)hexane, 1,1-di(t-butylperoxy)-3,3,5-trimethyl cyclohexane, benzoyl peroxide, lauroyl peroxide, dilauroyl peroxide, 2,5-dimethyl-2,5-di(tert-butylperoxy)hexyne-3, and mixtures thereof. Also, diaryl peroxides, ketone peroxides, peroxydicarbonates, peroxyesters, dialkyl peroxides, hydroperoxides, peroxyketals and mixtures thereof may be used.

As indicated above, in one embodiment, the elastomer may not be cured using a peroxide curing agent. In this regard, it may be present in the TPV formulation in an amount of 0.5 wt. % or less, such as 0.2 wt. % or less, such as 0.1 wt. % or less, such as about 0 wt. %. In other words, it may be present in an amount of 2 phr or less, such as 1 phr or less, such as 0.5 phr or less, such as 0.1 phr or less, such as about 0 phr.

However, in another embodiment, the curing agent may be a peroxide curing agent. As indicated below, peroxides may also be utilized to crosslink the ethylene polymer. In this regard, the thermoplastic formulation may include a curing agent (e.g., for the elastomer) and a crosslinking agent (e.g., for the ethylene polymer) in certain embodiments. In such embodiments, a peroxide may be provided wherein such peroxide serves as both the crosslinking agent and the curing agent. The peroxide may be the same type of peroxide for both functions in one embodiment. In another embodiment, different peroxides, such as a first peroxide and a second peroxide, may be utilized.

The silicon-containing curing agents generally include silicon hydride compounds having at least two SiH groups. These compounds react with carbon-carbon double bonds of unsaturated polymers in the presence of a hydrosilylation catalyst. Silicon hydride compounds include, but are not limited to, methylhydrogen polysiloxanes, methylhydrogen dimethyl-siloxane copolymers, alkyl methyl polysiloxanes, bis(dimethylsilyl)alkanes, bis(dimethylsilyl)benzene, and mixtures thereof.

As noted above, hydrosilylation curing may be conducted in the presence of a catalyst. These catalysts can include, but are not limited to, peroxide catalysts and catalysts including transition metals of Group Vill. These metals include, but are not limited to, palladium, rhodium, and platinum, as well as complexes of these metals.

In certain embodiments, the curing composition also includes one or both of ZnO and SnCl₂. In one embodiment, the curing composition may include zinc oxide. In another embodiment, the curing composition may include stannous chloride. In a further embodiment, the curing composition may include zinc oxide and stannous chloride.

Coagents may also be employed with the curing agents. The coagent may include a multi-functional acrylate ester, a multi-functional methacrylate ester, or combination thereof. In other words, the coagents include two or more organic acrylate or methacrylate substituents. Examples of multi-functional acrylates include diethylene glycol diacrylate, trimethylolpropane triacrylate (TMPTA), ethoxylated trimethylolpropane triacrylate, propoxylated trimethylolpropane triacrylate, propoxylated glycerol triacrylate, pentaerythritol triacrylate, bistrimethylolpropane tetraacrylate, pentaerythritol tetraacrylate, ethoxylated pentaerythritol tetraacrylate, ethoxylated pentaerythritol triacrylate, cyclohexane dimethanol diacrylate, ditrimethylolpropane tetraacrylate, or combinations thereof. Examples of multi-functional methacrylates include trimethylol propane trimethacrylate (TMPTMA), ethylene glycol dimethacrylate, butanediol dimethacrylate, butylene glycol dimethacrylate, diethylene glycol dimethacrylate, polyethylene glycol dimethacrylate, allyl methacrylate, or combinations thereof. The coagent may also include triallylcyanurate, triallyl isocyanurate, triallyl phosphate, sulfur, N-phenyl-bis-maleamide, zinc diacrylate, zinc dimethacrylate, divinyl benzene, 1,2-polybutadiene, trimethylol propane trimethacrylate, tetramethylene glycol diacrylate, trifunctional acrylic ester, dipentaerythritolpentacrylate, polyfunctional acrylate, retarded cyclohexane dimethanol diacrylate ester, polyfunctional methacrylates, acrylate and methacrylate metal salts, oximer for e.g., quinone dioxime, and the like.

Furthermore, an oil can be employed in the cure system. The oil may also be referred to as a process oil, an extender oil, or plasticizer. Useful oils include mineral oils, synthetic processing oils, or combinations thereof and may act as plasticizers. The plasticizers include, but are not limited to, aromatic, naphthenic, and extender oils. Exemplary synthetic processing oils include low molecular weight polylinear alpha-olefins, and polybranched alpha-olefins. Suitable esters include monomeric and oligomeric materials having an average molecular weight below about 2,000 g/mole, or below about 600 g/mole. Specific examples include aliphatic mono- or diesters or alternatively oligomeric aliphatic esters or alkyl ether esters.

The curing composition may be added in one or more locations, including the feed hopper of a melt mixing extruder. In some embodiments, the curing agent and any additional coagents may be added to the TPV formulation together: in other embodiments, one or more coagents may be added to the TPV formulation at different times from any one or more of the curing agents, as the TPV formulation is undergoing processing to form a TPV.

In general, the amount of curing agent present should be sufficient to at least partially vulcanize the elastomer and in some embodiments, to completely vulcanize the elastomer.

### D. Other Additives

The thermoplastic vulcanizate formulations of some embodiments may optionally further comprise one or more additives. Suitable additional TPV additives include, but are not limited to, plasticizers, process oils, fillers, processing aids, acid scavengers, antioxidants, stabilizers, lubricants, antiblocking agents, anti-static agents, waxes, foaming agents, colorants/pigments, flame retardants and other processing aids and/or the like. In this regard, the resulting thermoplastic vulcanizate may also comprise one or more of such additives.

Any suitable process oil may be included in some embodiments. In particular embodiments, process oils may be selected from: (i) extension oil, that is, oil present in an oil-extended rubber (such as oil present with the elastomer); (ii) free oil, that is, oil that is added during the vulcanization process (separately from any other TPV formulation component such as the elastomer and thermoplastic vulcanizate); (iii) curative oil, that is, oil that is used to dissolve/disperse the curing agents, for example, a curative-in-oil dispersion such as a phenolic resin-in-oil (and in such embodiments, the curing composition may therefore be present in the TPV formulation as the curative-in-oil additive); and (iv) any combination of the foregoing oils from (i)-(iii). Thus, process oil may be present in a TPV formulation as part of another component (e.g., as part of the elastomer when the process oil is an extension oil, such that the elastomer comprises elastomer and extension oil; or as part of the curing composition when the process oil is the carrier of a curative-in-oil, such that the curing composition comprises the curative oil and a curing agent). On the other hand, process oil may be added to the TPV separately from other components, i.e., as free oil.

The extension oil, free oil, and/or curative oil may be the same or different oils in various embodiments. Process oils may include one or more of (i) “refined” or “mineral” oils, and (ii) synthetic oils. As used herein, mineral oils refer to any hydrocarbon liquid of lubricating viscosity (i.e., a kinematic viscosity at 100° C. of 1 mm²/sec or more) derived from petroleum crude oil and subjected to one or more refining and/or hydroprocessing steps (such as fractionation, hydrocracking, dewaxing, isomerization, and hydrofinishing) to purify and chemically modify the components to achieve a final set of properties. Such “refined” oils are in contrast to “synthetic” oils, which are manufactured by combining monomer units into larger molecules using catalysts, initiators, and/or heat.

In general, either refined or synthetic process oils according to some embodiments may include, but are not limited to, any one or more of aromatic, naphthenic, and paraffinic oils. Exemplary synthetic processing oils are polylinear alpha-olefins, polybranched alpha-olefins, and hydrogenated polyalphaolefins. The compositions of some embodiments of this invention may include organic esters, alkyl ethers, or combinations thereof.

In certain embodiments, at least a portion of the process oil (e.g., all or a portion of any one or more of extension oil, free oil, and/or curative oil) is a low aromatic/sulfur content oil and has (i) an aromatic content of less than 5 wt. %, or less than 3.5 wt. %, or less than 1.5 wt. %, based on the weight of that portion of the process oil; and (ii) a sulfur content of less than 0.3 wt. %, or less than 0.003 wt. %, based on the weight of that portion of the process oil. Aromatic content may be determined in a manner consistent with method ASTM D2007. The percentage of aromatic carbon in the process oil of some embodiments is preferably less than 2, 1, or 0.5%. In certain embodiments, there are no aromatic carbons in the process oil. The proportion of aromatic carbon (%) as used herein is the proportion (percentage) of the number of aromatic carbon atoms to the number of all carbon atoms determined by the method in accordance with ASTM D2140.

Suitable process oils of particular embodiments may include API Group I, 11, Ill, IV, and V base oils. See API 1509, Engine Oil Licensing and Certification System, 17th Ed., September 2012, Appx. E, incorporated herein by reference.

A TPV formulation of some embodiments may also or instead include a polymeric processing additive. The processing additive employed in such embodiments is a polymeric resin that has a very high melt flow index. These polymeric resins include both linear and branched molecules that have a melt flow rate that is greater than about 500 dg/min, more preferably greater than about 750 dg/min, even more preferably greater than about 1000 dg/min, still more preferably greater than about 1200 dg/min, and still more preferably greater than about 1500 dg/min. The thermoplastic elastomers of the present disclosure may include mixtures of various branched or various linear polymeric processing additives, as well as mixtures of both linear and branched polymeric processing additives. Reference to polymeric processing additives will include both linear and branched additives unless otherwise specified. The preferred linear polymeric processing additives are polypropylene homopolymers. The preferred branched polymeric processing additives include diene-modified polypropylene polymers.

In addition, the formulation may also include reinforcing and/or non-reinforcing fillers. Fillers and extenders that can be utilized include conventional inorganics such as calcium carbonate, clays, silica, talc, titanium dioxide, as well as organic, such as carbon block, and organic and inorganic nanoscopic fillers.

In certain embodiments, the TPV formulation may include acid scavengers. These acid scavengers may be added to the thermoplastic vulcanizate after the desired level of cure has been achieved. Preferably, the acid scavengers are added after dynamic vulcanization. Useful acid scavengers include hydrotalcites. Both synthetic and natural hydrotalcites can be used. An exemplary natural hydrotalcite can be represented by the formula Mg₆Al₂(OH)₁₆CO₃·4H₂O. Synthetic hydrotalcite compounds may have formula Mg_{4.3}Al₂(OH)₁₂·6CO₃·mH₂O or Mg_{4.5}Al₂(OH)₁₃CO₃·3.5H₂O.

These additives can be utilized in an amount to provide the desired effect. In this regard, the additives may be present in an amount of up to about 50 weight percent of the total TPV formulation or TPV. In this regard, a respective additive and/or combination of additives may be present in an amount of 0.001 wt. % or more, such as 0.01 wt. % or more, such as 0.05 wt. % or more, such as 0.1 wt. % or more, such as 0.2 wt. % or more, such as 0.3 wt. % or more, such as 0.5 wt. % or more, such as 1 wt. % or more, such as 2 wt. % or more, such as 3 wt. % or more, such as 5 wt. % or more, such as 8 wt. % or more, such as 10 wt. % or more, such as 12 wt. % or more, such as 15 wt. % or more, such as 20 wt. % or more, such as 25 wt. % or more, such as 30 wt. % or more. They may be present in an amount of 50 wt. % or less, such as 40 wt. % or less, such as 30 wt. % or less, such as 25 wt. % or less, such as 20 wt. % or less, such as 18 wt. % or less, such as 15 wt. % or less, such as 13 wt. % or less, such as 10 wt. % or less, such as 8 wt. % or less, such as 6 wt. % or less, such as 4 wt. % or less, such as 3 wt. % or less, such as 2 wt. % or less, such as 1 wt. % or less, such as 0.5 wt. % or less. In another embodiment, such aforementioned percentages may be based on the weight of the ethylene polymer. In a further embodiment, such aforementioned percentages may be based on the weight of the elastomer. In an even further embodiment, such aforementioned percentages may be based on the combined weight of the ethylene polymer and elastomer.

### E. TPV Formulation

In general, as used herein, a “TPV formulation” refers to the mixture of ingredients blended or otherwise compiled before or during processing of the TPV formulation in order to form a TPV, in particular a crosslinkable TPV and/or a crosslinked TPV as defined herein. This is in recognition of the fact that the ingredients that are mixed together and then processed may or may not be present in the final TPV in the same amounts added to the formulation, depending upon the reactions that take place among some or all of the ingredients during processing of the mixed ingredients.

In general, a TPV formulation according to various embodiments includes the elastomer, ethylene polymer, and curing agent (or curing composition) along with any other optional additives. As will be discussed in more detail below, the TPV formulation undergoes processing, including dynamic vulcanization, to form a TPV. In certain embodiments, any other additives may be added to the TPV formulation during processing, either before or after dynamic vulcanization.

Relative amounts of the various components in TPV formulations are conveniently characterized based upon the amount of elastomer in the formulation, in particular in parts by weight per hundred parts by weight of rubber (phr). In embodiments wherein the elastomer comprises both elastomer with an extension oil, as is common for much commercially available elastomers such as EPDM, the phr amounts are based only upon the amount of elastomer, exclusive of extension oil present with the elastomer. Thus, as an example, an elastomer containing 100 parts EPDM (rubber) and 75 parts extension oil would in fact be considered present in a TPV formulation at 175 phr (i.e., on the basis of the 100 parts EPDM rubber). If such a TPV formulation were further characterized as containing 50 phr ethylene polymer, the formulation would include 50 parts by weight of ethylene polymer in addition to the 100 parts by weight elastomer and 75 parts by weight extension oil.

TPV formulations of some embodiments may include the ethylene polymer in an amount from about 20 to about 300 parts per hundred parts by weight of the elastomer or rubber (phr). In various embodiments, the ethylene polymer is included in a TPV formulation in an amount ranging from a low of any one of about 20, 25, 30, 35, 40, 45, 50, 55, 60, 65, 70, 75, 80, 85, 90, 95, 100, 105, 110, 115, 120, 125, 130, 135, 140, 145, 150, 165, 170, and 175 phr, to a high of any one of about 50, 60, 70, 80, 90, 100, 125, 150, 175, 200, 225, 250, 275, and 300 phr. The ethylene polymer may be included in an amount ranging from any of the aforementioned lows to any of the aforementioned highs, provided that the high value is greater than or equal to the low value. In particular embodiments, increasing amounts of ethylene polymer correspond to increasing hardness of the dynamically vulcanized TPV.

When the elastomer consists of elastomer only, it is by definition present at 100 phr (since it is the basis of the phr notation). However, in embodiments wherein the elastomer component comprises a constituent other than an elastomer, such as an extender oil, the elastomer may be included in a TPV formulation in an amount ranging from a low of any one of about 100.05, 100.1, 100.15, 100.2, 105, 110, 115, and 120 phr to a high of any one of about 110, 120, 125, 150, 175, 200, 225, and 250 phr.

As previously noted, TPV formulations of certain embodiments may optionally include additional TPV additives. Amounts of additional additive are separate and in addition to those additives already included in another component of a TPV formulation. For instance, any additive such as extension oil included with the elastomer has already been accounted for as part of the amount of elastomer added to the formulation; recited amounts of additional additives therefore are exclusive of additives already included with the elastomer. Additional additives may be present in a TPV formulation in the aggregate in an amount ranging from about 0 phr to about 300 phr. In certain embodiments, additional additives may in the aggregate be present in the TPV in an amount ranging from a low of any one of about 0, 5, 10, 15, 25, 30, 40, 50, 60, 70, 80, 90, and 100 phr, to a high of any one of about 25, 30, 40, 50, 60, 80, 100, 125, 150, 175, 200, 225, 250, 275, and 300 phr. The additional additives may be included in an aggregate amount ranging from any one of the aforementioned lows to any one of the aforementioned highs, provided that the high value is greater than or equal to the low value. In one embodiment, such aforementioned phr may refer to the additional additives individually rather than the aggregate.

For convenience, components of TPV formulations of various embodiments may alternatively be characterized based upon their weight percentages in the TPV formulation according to the following:

The ethylene polymer(s) may be present in a TPV formulation in amounts ranging from a low of any one of about 5, 6, 7, 8, 9, 10, 11, 12, 13, 14, 15, 16, 17, 18, 19, 20, 21, 22, 23, 24, and 25 wt. % to a high of any one of about 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, and 60 wt. %, provided that the high is greater than or equal to the low.

The elastomer(s) may be present in a TPV formulation in amounts ranging from a low of any one of about 3, 4, 5, 6, 7, 8, 9, 10, 11, 12, 13, 14, 15, 16, 17, 18, 19, 20, 25, 30, and 35 wt. % to a high of any one of about 35, 40, 45, 50, 55, 60, 65, 70, 75, and 80 wt. %, provided that the high is greater than or equal to the low, and that the elastomeric(s) are present in the TPV formulation within the range of about 20 to about 300 phr.

The optional additional TPV additive(s) may be present in a TPV formulation in aggregate amounts ranging from a low of any one of about 0, 5, 10, 15, 20, 25, 30, 35, and 40 wt. % to a high of any one of about 30, 35, 40, 45, 50, 55, 60, and 65 wt. %, provided that the high is greater than or equal to the low, and that the additive(s) are present in the TPV formulation within the range of about 0 to about 300 phr.

### F. Processing TPV Formulations

The thermoplastic vulcanizate of the present disclosure is prepared by dynamic vulcanization techniques. The term “dynamic vulcanization” refers to a vulcanization or curing process for a TPV formulation comprising an elastomer, wherein the elastomer is vulcanized under conditions of high shear mixing at a temperature above the melting point of the ethylene polymer to produce a thermoplastic vulcanizate. In dynamic vulcanization, an elastomer is simultaneously crosslinked and dispersed as fine particles within the ethylene polymer, although other morphologies, such as co-continuous morphologies, may exist depending on the degree of cure, the elastomer to resin viscosity ratio, the intensity of mixing, the residence time, and the temperature.

In some embodiments, processing may include melt blending, in a chamber, a TPV formulation comprising the elastomer, ethylene polymer, and curing agent. The chamber may be any vessel that is suitable for blending the selected composition under temperature and shearing force conditions necessary to form a thermoplastic vulcanizate. In this respect, the chamber may be a mixer, such as Banbury™ mixers or Brabender™ mixers, and certain mixing extruders such as co-rotating, counter-rotating, and twin-screw extruders, as well as co-kneaders, such as Buss® kneaders. According to one embodiment, the chamber is an extruder, which may be a single or multi-screw extruder. The term “multi-screw extruder” means an extruder having two or more screws; with two and three screw extruders being exemplary, and two or twin screw extruders being preferred in some embodiments. The screws of the extruder may have a plurality of lobes; two and three lobe screws being preferred. It will readily be understood that other screw designs may be selected in accordance with the methods of embodiments of the present disclosure. In some embodiments, dynamic vulcanization may occur during and/or as a result of extrusion. After discharging from the mixer, the blend containing the vulcanized rubber and the thermoplastic can be milled, chopped, extruded, pelletized, injection-molded, or processed by any other desirable technique.

The dynamic vulcanization of the elastomer may be carried out to achieve relatively high shear. In particular embodiments, the blending may be performed at a temperature not exceeding about 400° C., preferably not exceeding about 300° C., and more preferably not exceeding about 250° C. The minimum temperature at which the melt blending is performed is generally higher than or equal to about 130° C., preferably higher than or equal to about 150° C. and more particularly higher than about 180° C. The blending time is chosen by taking into account the nature of the compounds used in the TPV formulation and the blending temperature. The time generally varies from about 5 seconds to about 120 minutes, and in most cases from about 10 seconds to about 30 minutes.

Dynamic vulcanization in some embodiments may include phase inversion. As those skilled in the art appreciate, dynamic vulcanization may begin by including a greater volume fraction of rubber than ethylene polymer. As such, the ethylene polymer may be present as the discontinuous phase when the rubber volume fraction is greater than that of the volume fraction of the ethylene polymer. As dynamic vulcanization proceeds, the viscosity of the rubber increases and phase inversion occurs under dynamic mixing. In other words, upon phase inversion, the ethylene polymer phase becomes the continuous phase.

Other additive(s) are preferably present within the TPV formulation when dynamic vulcanization is carried out, although in some embodiments, one or more other additives (if any) may be added to the composition after the curing and/or phase inversion (e.g., after the dynamic vulcanization portion of processing). The additional additives may be included after dynamic vulcanization by employing a variety of techniques. In one embodiment, they can be added while the thermoplastic vulcanizate remains in its molten state from the dynamic vulcanization process. For example, the additional additives can be added downstream of the location of dynamic vulcanization within a process that employs continuous processing equipment, such as a single or twin screw extruder. In other embodiments, the thermoplastic vulcanizate can be “worked-up” or pelletized, subsequently melted, and the additional additives can be added to the molten thermoplastic vulcanizate product. This latter process may be referred to as a “second pass” addition of the ingredients.

Despite the fact that the elastomer may be partially or fully cured, the thermoplastic vulcanizate can be processed and reprocessed by conventional plastic processing techniques such as extrusion, injection molding, and compression molding. The elastomer within these thermoplastic elastomers is usually in the form of finely-divided and well-dispersed particles of vulcanized or cured rubber within a continuous thermoplastic phase or matrix, although a co-continuous morphology or a phase inversion is also possible. In those embodiments where the cured rubber is in the form of finely-divided and well-dispersed particles within the thermoplastic medium, the rubber particles may have an average diameter that is less than 50 μm, such as less than 30 μm, such as less than 10 μm, such as less than 5 μm, such as less than 1 μm. In preferred embodiments, at least 50%, such as at least 60%, such as at least 75% of the rubber particles may have an average diameter of less than 20 μm, such as less than 18 μm, such as less than 15 μm, such as less than 12 μm, such as less than 10 μm, such as less than 8 μm, such as less than 6 μm, such as less than 5 μm, such as less than 2 μm, such as less than 1 μm.

The resulting thermoplastic vulcanizate may have the desired density (or specific gravity) that allows it to be utilized for a molded article as described herein. In this regard, the density may be 0.3 g/cm³ or more, such as 0.4 g/cm³ or more, such as 0.5 g/cm³ or more, such as 0.6 g/cm³ or more, such as 0.65 g/cm³ or more, such as 0.7 g/cm³ or more, such as 0.75 g/cm³ or more, such as 0.8 g/cm³ or more, such as 0.85 g/cm³ or more, such as 0.9 g/cm³ or more, such as 0.95 g/cm³ or more, such as 1 g/cm³ or more, such as 1.05 g/cm³ or more, such as 1.1 g/cm³ or more, such as 1.15 g/cm³ or more, such as 1.2 g/cm³ or more. The density may be 2 g/cm³ or less, such as 1.8 g/cm³ or less, such as 1.6 g/cm³ or less, such as 1.4 g/cm³ or less, such as 1.3 g/cm³ or less, such as 1.2 g/cm³ or less, such as 1.1 g/cm³ or less, such as 1.0 g/cm³ or less, such as 0.95 g/cm³ or less, such 0.90 g/cm³ or less, such as 0.7 g/cm³ or less, such as 0.6 g/cm³ or less, such as 0.55 g/cm³ or less.

### G. Crosslinking Ethylene Polymer

As described herein, a crosslinkable ethylene polymer is utilized to form a crosslinked ethylene polymer present in the crosslinked thermoplastic vulcanizate. In this regard, the crosslinkable ethylene polymer may be crosslinked using means generally known in the art. For instance, the crosslinking may be via radiation or chemical crosslinking using a crosslinking agent. In one embodiment, the crosslinking may be via irradiation. Suitable means of irradiation include, but are not limited to, e-beam radiation.

In another embodiment, the crosslinking may be via chemical crosslinking. This may include crosslinking utilizing a peroxide, via moisture cure, and other well-known methods. In one embodiment, crosslinking is conducted using a peroxide. In another embodiment, crosslinking is conducted via moisture cure.

Peroxide crosslinking uses an organic peroxide. For instance, the organic peroxide can initiate a free radical reaction in the ethylene polymer and the resulting free radicals abstract hydrogen ions from the polymer chains, enabling them to form covalent bonds between the chains. Crosslinking preferably occurs in the presence of a free-radical initiator comprising an organic peroxide, an organic perester, and/or an azo compound. Examples of such compounds include benzoyl peroxide, dichlorobenzoyl peroxide, dicumyl peroxide, di-tert-butyl peroxide, 2,5-dimethyl-2,5-di(peroxybenzoate)hexyne-3,1,4-bis(tert-butylperoxyisopropyl)benzene, lauroyl peroxide, tert-butyl peracetate, 2,5-dimethyl-2,5-di(tert-butylperoxy)hexyne-3,2,5-dimethyl-2,5-di(tert-butylperoxy)hexane, tert-butyl perbenzoate, tert-butylperphenyl acetate, tert-butyl perisobutyrate, tert-butyl per-sec-octoate, tert-butyl perpivalate, cumyl perpivalate and tert-butyl perdiethylacetate, azoisobutyronitrile, dimethyl azoisobutyrate. In one particular embodiment, the organic peroxide comprises 2,5-dimethyl-2,5-di(tert-butylperoxy)hexane.

In moisture cure embodiments, a copolymer of ethylene and a vinyl silane can be reacted with water, usually in the presence of a catalyst, to effect crosslinking. The product is made on conventional thermoplastic processing equipment and then cured off-line by exposing it to moisture. The cure rate depends on the moisture level, temperature, and thickness and can be accelerated by contact with low-pressure steam or hot water. However, it should be understood that crosslinking under ambient conditions may also be possible.

The ethylene polymer is capable of being crosslinked by a reactive unsaturated silane compound. Silane crosslinking processes well-known in the art include the commercially available MONOSIL process developed by Maillefer and BICC and the SIOPLAS process developed by Dow Corning. In the SIOPLAS process, or two-step process, an ethylene polymer is first graft-modified in a compounding mixer or extruder with a reactive silane compound and a free radical initiator, such as dicumyl peroxide, for example, to produce a silane-grafted ethylene polymer. The silane-grafted ethylene polymer is compounded with a silanol condensation catalyst and melt-extruded in the desired form or shape, followed by curing (crosslinking) by heat and/or moisture, such as in a water bath or a steam bath. In warm and humid climates, curing can take place under ambient conditions. In the MONOSIL or one-step process, the ethylene polymer, reactive silane compound, free radical initiator and silanol condensation catalyst are all fed into an extruder and melt extruded in a desired form or shape, followed by curing by heat and/or moisture, as in the two-step process.

The reactive silane compound utilized above can be an unsaturated silane compound having one or more hydrolyzable groups. These silanes may include aminosilanes, vinylsilanes, vinylaminosilanes, and the like. Typical reactive silane compounds include an alkenyl group such as vinyl, allyl, isopropenyl, butenyl, cyclohexenyl, or γ-(meth)acryloxy allyl, and a hydrolyzable group such as a hydrocarbyloxy, hydrocarbonyloxy or hydrocarbylamino group. Specific examples of hydrolyzable groups include methoxy, ethoxy, formyloxy, acetoxy, propionyloxy, and alkylamino or acrylamino groups. Examples of such silane compounds include, but are not limited to, vinyl triethoxysilane, vinyl-tris-(beta-methoxyethoxy)silane, vinyl trimethoxysilane, methacryloylpropyltrimethoxysilane, gamma-amino-propyl triethoxysilane, gamma-mercaptopropyltrimethoxysilane and the like, and mixtures thereof. A suitable reactive silane is vinyl trimethoxysilane.

The amount of silane used is readily determined by one skilled in the art, based on the processing conditions, the specific silane used, and other well-known factors. Typical amounts of silane compound are from about 0.5 to about 10, such as from about 0.5 to about 10 parts by weight per hundred parts by weight of the ethylene polymer.

The free radical initiator can be a peroxide or azo compound which decomposes to form peroxyl or azyl radicals or can be ionizing radiation. Typical peroxides include, for example, dicumyl peroxide, di-tert-butyl peroxide, t-butyl perbenzoate, benzoyl peroxide, cumene hydroperoxide, t-butyl peroctoate, methyl ethyl ketone peroxide, 2,5-dimethyl-2,5-di(t-butyl peroxy)hexane, lauryl peroxide and tert-butyl peracetate. A suitable azo compound is azobisisobutyl nitrite. A particular peroxide compound is dicumyl peroxide. Another particular peroxide compound is 2,5-dimethyl-2,5-di(t-butyl peroxy)hexane. The amount of free radical initiator is readily determined by one skilled in the art, and is typically from about 0.01 to about 0.2, such as from about 0.04 to about 0.15 parts by weight per hundred parts by weight of the ethylene polymer.

The silanol condensation catalyst can be any compound that promotes the condensation crosslinking reaction, such as organic bases, carboxylic acids, and organometallic compounds including organic titanates and complexes or carboxylates of lead, cobalt, iron, nickel, zinc or tin. Specific catalysts include, for example, dibutyl tin dilaurate, dioctyl tin maleate, dibutyl tin diacetate, dibutyl tin dioctoate, dibutyl tin didodecanoate, stannous acetate, stannous octoate, lead naphthenate, zinc caprylate, and cobalt naphthenate. A particular tin carboxylate is dibutyl tin didodecanoate. The catalyst is used in a catalytically effective amount, readily determined by one skilled in the art. Typical catalyst amounts are from about 0.01 to about 0.1 parts by weight per hundred parts by weight of the ethylene polymer.

The peroxide-initiated reaction of the reactive silane compound, such as vinyl trimethoxysilane, and an ethylene polymer yields a grafted polymer having an ethylene polymer backbone structure with pendant silyl, such as ethyltrimethoxysilyl, moieties. In the crosslinking reaction, methoxy groups are hydrolyzed to form methanol and pendant ethyldimethoxysilanolyl groups, which undergo condensation reactions with other ethyldimethoxysilanolyl groups to eliminate water and form an Si—O—Si linkage between the pendant silyl moieties.

The crosslinking agent may be provided with a carrier. For instance, the carrier may be a porous polymer, silica, titanium dioxide, carbon black, etc. In one embodiment, the carrier may be a silica.

As indicated above, the crosslinking may be conducted via irradiation. Irradiation crosslinking uses ionizing radiation such as from a high-energy electron accelerator. The ethylene polymer may be provided with additives to accelerate the crosslinking process. Regardless, once a desired shape is formed, the shape can be cured in-line or off-line by undergoing irradiation, such as by exposing it to an electron beam. In an embodiment, the formed shape can be taken up on a large coil or reel and rewound through the electron beam unit. Depending on the thickness of the molded article (e.g., wall of the part or layer of the conduit), it may be necessary for repeated runs through the electron beam unit to obtain the desired crosslinking density.

Upon crosslinking, the crosslinked ethylene polymer may have a degree of crosslinking of 30% or more, such as 40% or more, such as 50% or more, such as 60% or more, such as 65% or more, such as 70% or more, such as 75% or more, such as 80% or more, such as 85% or more. The degree of crosslinking may be less than 100%, such as 95% or less, such as 93% or less, such as 91% or less, such as 90% or less, such as 89% or less, such as 85% or less, such as 80% or less, such as 75% or less. The degree of crosslinking as measured by the gel content may be determined in accordance with ASTM D2765-01.

### H. Crosslinked Thermoplastic Vulcanizate

As indicated herein, a crosslinked thermoplastic vulcanizate can be formed. In particular, the molded article can comprise the crosslinked thermoplastic vulcanizate. For instance, at least a portion (e.g., a wall, a thickness, a layer) of such molded article can comprise the crosslinked thermoplastic vulcanizate. In particular, a molded article such as a conduit as described below can include a layer formed from the crosslinked thermoplastic vulcanizate. The manner in which the crosslinked thermoplastic vulcanizate can be formed may vary depending on various factors, such as the method of crosslinking, etc.

In one embodiment, the crosslinked thermoplastic vulcanizate can be formed by providing a thermoplastic vulcanizate formulation comprising a crosslinkable ethylene polymer, an elastomer, a curing agent, and a crosslinking agent. In this regard, the components required for crosslinking the ethylene polymer and the for curing the elastomer may be provided during one process. In such method, the elastomer may be at least partially cured. For instance, the method may include a step of dynamically vulcanizing the elastomer using the curing agent. This may in turn provide a crosslinkable thermoplastic vulcanizate wherein the crosslinkable ethylene polymer can be crosslinked to provide the crosslinked ethylene polymer and the crosslinked thermoplastic vulcanizate. The crosslinking may be initiated at the appropriate conditions as described above depending on the particular crosslinking agent and techniques known in the art. The crosslinking may occur concurrently with the dynamic vulcanizing. Alternatively, the crosslinking may occur after the dynamic vulcanizing or at least after the dynamic vulcanizing has started.

In one embodiment, the crosslinked thermoplastic vulcanizate can be formed by providing a thermoplastic vulcanizate formulation comprising a crosslinkable ethylene polymer, an elastomer, and a curing agent. The elastomer may be at least partially cured. For instance, the method may include a step of dynamically vulcanizing the elastomer using the curing agent. This may in turn provide a crosslinkable thermoplastic vulcanizate wherein the crosslinkable ethylene polymer can be crosslinked via exposure to irradiation to provide the crosslinked ethylene polymer and the crosslinked thermoplastic vulcanizate. In such embodiment, the irradiation may be provided in-line during the manufacture of the crosslinkable thermoplastic vulcanizate. Alternatively, such irradiation may be provided off-line, such as at a later time after the manufacture of the crosslinkable thermoplastic vulcanizate. For instance, in this latter scenario, the method may simply require a step of crosslinking the crosslinkable ethylene polymer in the crosslinkable thermoplastic vulcanizate by exposure to irradiation to provide the crosslinked ethylene polymer and the crosslinked thermoplastic vulcanizate.

In another embodiment, the crosslinked thermoplastic vulcanizate can be formed by blending a crosslinking agent and a crosslinkable thermoplastic vulcanizate comprising a crosslinkable ethylene polymer and an at least partially cured elastomer. The blending may be via techniques generally known in the art, such as a mixer, an extruder, etc. In this regard, the extruder may be a single screw extruder, a twin screw extruder etc. Such blender or extruder may be utilized as a feed to producing the molded article as defined herein. Then, the crosslinkable ethylene polymer can be crosslinked to provide the crosslinked ethylene polymer and the crosslinked thermoplastic vulcanizate. The crosslinking may be initiated at the appropriate conditions as described above depending on the particular crosslinking agent and techniques known in the art.

### I. Formation of Molded Article

The thermoplastic vulcanizate may be shaped into the form of a molded article. For instance, the thermoplastic vulcanizate may be utilized to form an entire molded article or at least part of a molded article. For instance, the thermoplastic vulcanizate may be utilized to form a layer, a wall, a thickness, a section, etc. of a molded article.

Furthermore, the molded article may be formed using any of a variety of techniques as is known in the art. For instance, the thermoplastic vulcanizate can advantageously be fabricated by employing typical molding processes, such as injection molding, extrusion molding, compression molding, blow molding, rotational molding, thermoforming, overmolding, etc. In general, these processes may include heating the thermoplastic vulcanizate to a temperature that is equal to or in excess of the melt temperature of the ethylene polymer to form a pre-form. Using injection molding as an example, the thermoplastic vulcanizate may be heated for a mold cavity to then form the molded article, cooling the molded article to a temperature at or below the crystallization temperature of the thermoplastic vulcanizate, and releasing the molded article from a mold. The mold cavity defines the shape of the molded article. The molded article is cooled within the mold at a temperature at or below the crystallization temperature of the thermoplastic vulcanizate and the molded article can subsequently be released from the mold. The process may also utilize extrusion molding to form the molded article, such as a conduit. In this regard, the thermoplastic vulcanizate may be extruded as described herein. Upon exiting the extruder, the thermoplastic vulcanizate may be formed or shaped to form the molded article. As one example, the thermoplastic vulcanizate may be formed or shaped to form a layer (e.g., outer sheath) of a conduit, such as a wire or cable. Such molded article may be formed by using a particular die to shape the thermoplastic vulcanizate as it exits the extruder.

Furthermore, as the ethylene polymer herein is crosslinked, the crosslinking may be conducted generally while the molded article is being made, after the molded article has been made, or both. For instance, while the thermoplastic vulcanizate is being shaped or formed into a molded article, the ethylene polymer may be crosslinked. In another embodiment, the thermoplastic vulcanizate may be shaped or formed into a molded article and thereafter the ethylene polymer may be crosslinked. In a further embodiment, the thermoplastic vulcanizate may be shaped or formed into a molded article and the ethylene polymer may be crosslinked during such shaping/forming and even thereafter.

When a crosslinking agent is utilized, the crosslinking agent may be provided with the thermoplastic vulcanizate. In another embodiment, the crosslinking agent may be provided in a subsequent step. In this regard, the method may include a step of blending the crosslinkable thermoplastic vulcanizate with a crosslinking agent. Then, the blend may be processed into the form a shape, such as the shape of a molded article. Thereafter, the method may also include a step of crosslinking the ethylene polymer to form the crosslinked ethylene polymer and corresponding crosslinked thermoplastic vulcanizate.

The crosslinking agent may be blended via techniques generally known in the art, such as a mixer, an extruder, etc. In this regard, the extruder may be a single screw extruder, a twin screw extruder etc. Such blender or extruder may be utilized as a feed to producing the molded article as defined herein. In this regard, the molded article may be formed in a variety of manners.

For instance, in one embodiment, the molded article may be formed by blending a crosslinking agent and a crosslinkable thermoplastic vulcanizate comprising a crosslinkable ethylene polymer and an at least partially cured elastomer to form a first blend. The first blend may be formed into a shape of the molded article. The crosslinkable ethylene polymer can be crosslinked to provide the crosslinked ethylene polymer and the crosslinked thermoplastic vulcanizate. The crosslinking may be initiated at the appropriate conditions as described above depending on the particular crosslinking agent and techniques known in the art. The crosslinking may occur concurrently during the shaping/forming. Alternatively, the crosslinking may occur after the shaping/forming. Even further, the crosslinking may occur both during the shaping/forming and after the shaping forming.

In another embodiment, the molded article may be formed by forming a crosslinkable thermoplastic vulcanizate comprising a crosslinkable ethylene polymer and an at least partially cured elastomer into a shape of the molded article. The crosslinkable ethylene polymer can be crosslinked by exposure to irradiation to provide the crosslinked ethylene polymer and the crosslinked thermoplastic vulcanizate. The crosslinking may occur concurrently during the shaping/forming. Alternatively, the crosslinking may occur after the shaping/forming. Even further, the crosslinking may occur both during the shaping/forming and after the shaping forming. In this regard, the irradiation may be provided in-line during the initial manufacture and shaping/forming of the molded article. Alternatively, such irradiation may be provided off-line, such as at a later time after the initial manufacture and shaping/forming of the molded article.

In another embodiment, the molded article may be formed by providing a thermoplastic vulcanizate formulation comprising a crosslinkable ethylene polymer, an elastomer, a curing agent, and a crosslinking agent. The method may include a step of dynamically vulcanizing the elastomer, such as by using the curing agent to form a crosslinkable thermoplastic vulcanizate. The crosslinkable thermoplastic vulcanizate can be formed into a shape of the molded article. The crosslinkable ethylene polymer can be crosslinked to provide the crosslinked ethylene polymer and the crosslinked thermoplastic vulcanizate. The crosslinking may be initiated at the appropriate conditions as described above depending on the particular crosslinking agent and techniques known in the art. The crosslinking may occur concurrently during the shaping/forming. Alternatively, the crosslinking may occur after the shaping/forming. Even further, the crosslinking may occur both during the shaping/forming and after the shaping forming. Furthermore, the crosslinking may occur concurrently with the dynamic vulcanizing. Alternatively, the crosslinking may occur after the dynamic vulcanizing or at least after the dynamic vulcanizing has started.

In another embodiment, the molded article may be formed by providing a thermoplastic vulcanizate formulation comprising a crosslinkable ethylene polymer, an elastomer, and a curing agent and dynamically vulcanizing the elastomer using the curing agent to form a crosslinkable thermoplastic vulcanizate. The crosslinkable thermoplastic vulcanizate can be formed into a shape of the molded article. The crosslinkable ethylene polymer can be crosslinked by exposure to irradiation to provide the crosslinked ethylene polymer and the crosslinked thermoplastic vulcanizate.

As indicated above, the crosslinking may be initiated at the appropriate conditions as described above depending on the particular crosslinking agent and techniques known in the art. In this regard, in an embodiment wherein the crosslinking agent includes a peroxide, it may be blended at a temperature below a decomposition point of the peroxide. Crosslinking can comprise heating the blend to a temperature above the decomposition point of the peroxide. The crosslinking in another embodiment can comprise an Engel process wherein after the peroxide is introduced, the blend is rammed through a head maintained above the decomposition temperature of the peroxide to form a crosslinked extrudate.

Furthermore, in an embodiment wherein the crosslinking agent includes a silane compound, in particular a moisture curable silane compound, the crosslinking can occur by exposure to moisture. The moisture exposure can include contacting with steam and/or hot water above a temperature of 40° C., or alternately, the moisture can be in the form of water at a temperature of 15° C. or less, e.g., a chilled water bath (10° C. or less) or ice. In another embodiment, the moisture or humidity in the air can cure the silane. The silane compound can be introduced as a copolymerized comonomer in a reactor copolymer in the ethylene polymer. The blending can include introducing a masterbatch comprising moisture-curing catalyst into the blend or formulation. Alternatively or additionally, the silane compound can be grafted onto the ethylene polymer by reactive extrusion, and the graft polymer can be mixed with a masterbatch comprising moisture-curing catalyst. In an embodiment, the method can comprise a one step process wherein the silane compound and a crosslinking catalyst are introduced into the blend or formulation in a single extruder. Alternatively or additionally, the method can comprise a two-step process wherein the silane compound and the crosslinking catalyst are serially introduced into the blend or formulation in separate extrusions.

### II. Applications

The crosslinkable and crosslinked thermoplastic vulcanizate may be utilized for a variety of applications. For instance, the thermoplastic vulcanizate may be utilized in applications that may need high temperature resistance and/or high strength. In this regard, the particular applications may not necessarily be limited. For instance, the thermoplastic vulcanizate can be utilized for molded articles in the automotive industry, construction industry, consumer goods industry, oilfield industry, medical industry, etc. In this regard, in one embodiment, the molded article may comprise an automotive molded article. In another embodiment, the molded article may comprise a consumer good. In a further embodiment, the molded article may comprise a medical device. In another further embodiment, the molded article may comprise an oilfield article.

The molded articles may include weather seals, hoses, belts, gaskets, moldings, boots, elastic fibers, conduits and like articles. In one embodiment, the molded articles may be include vehicle parts, such as but not limited to, weather seals, brake parts including, but not limited to cups, coupling disks, diaphragm cups, boots such as constant velocity joints and rack and pinion joints, tubing, sealing gaskets, parts of hydraulically or pneumatically operated apparatus, o-rings, pistons, valves, valve seats, valve guides, and other elastomeric polymer based parts or elastomeric polymers combined with other materials such as metal, plastic combination materials which will be known to those of ordinary skill in the art. In addition, the molded articles may include transmission belts including V-belts, toothed belts with truncated ribs containing fabric faced Vs, ground short fiber reinforced Vs or molded gum with short fiber flocked Vs. The molded articles may include weather seal extrudates for the construction and vehicle manufacture industries, and for liquid carrying hoses (e.g., under hood automotive).

Particularly, the thermoplastic vulcanizate may be utilized for forming a conduit. The conduit may include at least one layer formed from the thermoplastic vulcanizate, in particular the crosslinked thermoplastic vulcanizate, as defined herein. In this regard, the conduit may not necessarily be limited and may include a wire jacket, a cable jacket, a tube, a pipe, etc. In this regard, in one embodiment, the conduit may be utilized for transporting a gas, liquid, or the like. In another embodiment, the conduit may be a wire jacket or a cable jacket. In particular, the conduit may be utilized in auto applications, industrial applications, or oilfield applications.

In one particular embodiment, the conduit may be a wire jacket. In this regard, the present disclosure may also be directed to a wire including a wire jacket formed from the crosslinked thermoplastic vulcanizate as defined herein. The wire may also include one or more of a shielding, a wrapping, a conductor insulation, and a conductor. For instance, the wire jacket may define an interior opening or interior surface. In this regard, such aforementioned components may be housed or contained within such interior opening or the area defined by the interior surface.

In one particular embodiment, the conduit may be a cable jacket. In this regard, the present disclosure may also be directed to a cable including a cable jacket formed from the crosslinked thermoplastic vulcanizate as defined herein. The cable may also include one or more of a shielding, a wrapping, a conductor insulation, and a conductor. For instance, the cable jacket may define an interior opening or interior surface. In this regard, such aforementioned components may be housed or contained within such interior opening or the area defined by the interior surface.

In this regard, when the molded article is a conduit, such as a wire jacket or cable jacket, the internal components (e.g., shielding, wrapping, conductor insulation, conductor, etc.) may be provided during the manufacture of the conduit. For instance, the conduit may be formed, such as extruded, around such internal components.

By utilizing the crosslinked thermoplastic vulcanizate with the crosslinked ethylene polymer, the material may meet high temperature demands for certain applications while still demonstrating the necessary hardness, flexibility, and other mechanical properties.

The following test methods may be employed to determine the properties referenced herein.

### Test Methods

Melting Temperature, Glass Transition Temperature, Heat of Fusion: The melting temperature (“Tm”), glass transition temperature (“Tg”), and the heat of fusion (“Hf”) may be determined by differential scanning calorimetry (“DSC”) as is known in the art using commercially available equipment such as a TA Instruments Model Q100. Typically, 6 to 10 mg of the sample, that has been stored at room temperature (about 23° C.) for at least 48 hours, is sealed in an aluminum pan and loaded into the instrument at room temperature (about 23° C.). The sample is equilibrated at 25° C. and then it is cooled at a cooling rate of 10° C./min to −80° C. The sample is held at −80° C. for 5 min and then heated at a heating rate of 10 0./min to 25° C. The glass transition temperature is measured from this heating cycle (“first heat”). For samples displaying multiple peaks, the melting point (or melting temperature) is defined to be the peak melting temperature associated with the largest endothermic calorimetric response in that range of temperatures from the DSC melting trace. The T_{g} was measured by again heating the sample from −80° C. to 80° C., at a rate of 20° C./min (“second heat”). The glass transition temperature reported is the midpoint of step change when heated during the second heating cycle, Areas under the DSC curve are used to determine the heat of transition (heat of fusion, Hf, upon melting or heat of crystallization, Hc, upon crystallization, if the Hf value from the melting is different from the Hc value obtained for the heat of crystallization, then the value from the melting (Tm) shall be used), which can be used to calculate the degree of crystallinity (also called the percent crystallinity). The percent crystallinity (X %) is calculated using the formula: [area under the curve (in J/g)/H° (in J/g)]*100, where H° is the heat of fusion for the homopolymer of the major monomer component. These values for H° are to be obtained from the Polymer Handbook, Fourth Edition, published by John Wiley and Sons, New York 1999, except that a value of 290 Jig is used as the equilibrium heat of fusion (H°) for 100% crystalline polyethylene, a value of 140 J/g is used as the equilibrium heat of fusion (H°) for 100% crystalline polybutene, and a value of 207 J/g (H°) is used as the heat of fusion for a 100% crystalline polypropylene.

Tensile strength values (tensile strength at break, elongation at break) were reassured (machine direction (“MD”) in accordance with ASTM D412-16.

### Materials

The below examples were prepared using the materials below.

| | ML (1 + 4) | C₂ | Diene | Oil |
|---|---|---|---|---|
| | 125° C. | Wt % | Wt % | extension |
| EPDM 1 | 50 | 61 | 4.5 | 75 phr |
| EPDM 2 | 25 | 55 | 4.7 | — |
| EPDM 3 | 80 | 52 | 5.2 | — |
| EPDM 4 | 65 | 51 | 7.5 | — |
| EPDM 5 | 52 | 62 | 0.7 | 100 phr |

### EXAMPLE 1

The below samples were prepared to demonstrate the ability to make a thermoplastic vulcanizate using a different combination of elastomer, in particular EPDM, and ethylene polymer, in particular ethylene copolymers.

| Sample | 1 | 2 | 3 | 4 | 5 | 6 |
|---|---|---|---|---|---|---|
| Material Name | phr | phr | phr | phr | phr | phr |
| EPDM 1 | 175.00 | — | — | 175.00 | 175.00 | 175.00 |
| EPDM 2 | — | 100.00 | — | — | — | — |
| EPDM 3 | — | | 100.00 | — | — | — |
| LLDPE (0.5 MI; ethylene 1- | 30.00 | 30.00 | 30.00 | — | — | 15.00 |
| hexene copolymer) | | | | | | |
| LLDPE (1.0 MI; ethylene 1- | — | — | — | 30.00 | — | |
| butene LLDPE) | | | | | | |
| LDPE (1.0 MI; ethylene 1- | — | — | — | — | 30.00 | 15.00 |
| hexene copolymer) | | | | | | |
| Group II paraffinic oil | 5.00 | 75.00 | 75.00 | 5.00 | 5.00 | 5.00 |
| (paraffinic process oil) | | | | | | |
| Phenolic resin | 6.30 | 6.30 | 6.30 | 6.30 | 6.30 | 6.30 |
| ZnO | 1.50 | 1.50 | 1.50 | 1.50 | 1.50 | 1.50 |
| Clay | 5.00 | 5.00 | 5.00 | 5.00 | 5.00 | 5.00 |
| Total phr | 222.8 | 217.8 | 217.8 | 222.8 | 222.8 | 222.8 |
| Hardness (Shore A) | 42.6 | 30.5 | 36.5 | 40.1 | 43.4 | 45.0 |
| UTS (MPa) | 4.21 | 2.12 | 2.95 | 4.48 | 4.99 | 5.15 |
| UE (%) | 640 | 850 | 649 | 554 | 555 | 565 |
| M100 (MPa) | 1.30 | 0.66 | 1.11 | 1.19 | 1.23 | 1.19 |
| Tension Set (%) | 7.50 | 11.00 | 9.17 | 7.33 | 6.50 | 6.33 |
| Weight Gain (%) | 154.69 | 222.75 | 181.26 | 148.58 | 132.92 | 124.62 |
| Specific Gravity (g/cm³) | 0.8925 | 0.8942 | 0.8938 | 0.8912 | 0.8905 | 0.8927 |

### EXAMPLE 2

The below samples were prepared to demonstrate the ability to make a thermoplastic vulcanizate using a different combination of elastomer, in particular EPDM, and ethylene polymer, in particular ethylene copolymers, wherein the ethylene polymer content is varied.

| Sample | 7 | 8 | 9 | 10 | 11 |
|---|---|---|---|---|---|
| Material Name | phr | phr | phr | phr | phr |
| EPDM 2 | 100.00 | 100.00 | 100.00 | 100.00 | 100.00 |
| LLDPE (0.5 MI; | 30.00 | 40.00 | 50.00 | 60.00 | 70.00 |
| ethylene 1-hexene | | | | | |
| copolymer) | | | | | |
| Group II paraffinic oil | 75.00 | 75.00 | 75.00 | 75.00 | 75.00 |
| (paraffinic process oil) | | | | | |
| Phenolic resin | 6.30 | 6.30 | 6.30 | 6.30 | 6.30 |
| ZnO | 1.50 | 1.50 | 1.50 | 1.50 | 1.50 |
| Clay | 5.00 | 5.00 | 5.00 | 5.00 | 5.00 |
| Total phr | 217.8 | 227.8 | 237.8 | 247.8 | 257.8 |
| Hardness (Shore A) | 33.2 | 35.5 | 43.7 | 47.3 | 52.0 |
| UTS (MPa) | 2.49 | 3.28 | 4.13 | 4.46 | 5.30 |
| UE (%) | 713 | 814 | 789 | 795 | 736 |
| M100 (MPa) | 1.04 | 1.12 | 1.51 | 1.59 | 2.12 |
| Tension Set (%) | 8.83 | 14.17 | 13.67 | 18.50 | 16.83 |
| Specific Gravity (g/cm³) | 0.894 | 0.894 | 0.896 | 0.897 | 0.899 |

As can be observed, an increase in the ethylene polymer content results in an increase in certain properties, such as hardness, ultimate tensile strength, and 100% modulus. Meanwhile, the elongation is comparable for all of the samples and the tension set is comparable for the samples having a higher ethylene polymer content.

### EXAMPLE 3

The below samples were prepared to demonstrate the ability to make a thermoplastic vulcanizate using different curing systems. For instance, sample 12 was made using a phenolic curing system and sample 13 was made using an Si—H curing system.

| Sample | 12 | 13 |
|---|---|---|
| Material Name | phr | phr |
| EPDM 2 | 100.00 | — |
| LLDPE (0.5 MI; ethylene 1- | 30.00 | 50.00 |
| hexene copolymer) | | |
| Group II paraffinic oil | 75.00 | 10.00 |
| (paraffinic process oil) | | |
| Phenolic resin | 6.30 | — |
| ZnO | 1.50 | 1.50 |
| Clay | 5.00 | 10.00 |
| EPDM 5 (oil extended | — | 200.00 |
| ethylene-propylene-vinyl- | | |
| norbornene) | | |
| silicon hydride functional | — | 2.00 |
| alkylsiloxane | | |
| Catalyst | — | 2.50 |
| Total phr | 217.8 | 280.0 |
| Hardness (Shore A) | 33.2 | 64.0 |
| UTS (MPa) | 2.49 | 6.2 |
| UE (%) | 713 | 461 |
| M100 (MPa) | 1.04 | 2.4 |
| Torque increase after | 3.5 Nm | 2.5 Nm |
| Curatives | | |

### EXAMPLE 4

The below samples were prepared to demonstrate the ability to make a thermoplastic vulcanizate using different plasticizers. For instance, sample 14 was made using a paraffinic oil plasticizer and sample 15 was made using a hydrocarbon resin plasticizer, in particular a cycloaliphatic hydrocarbon resin plasticizer.

| Sample | 14 | 15 |
|---|---|---|
| Material Name | phr | phr |
| EPDM 1 | 175.00 | 175.00 |
| MDPE (ethylene 1-hexene | 48.00 | 48.00 |
| MDPE) | | |
| Group II paraffinic oil | 84.00 | — |
| (paraffinic process oil) | | |
| Phenolic resin | 6.30 | 6.30 |
| ZnO | 1.50 | 1.50 |
| Clay | 44.00 | 44.00 |
| Cycloaliphatic hydrocarbon | — | 60.00 |
| resin | | |
| Total phr | 358.8 | 334.8 |
| Hardness (Shore A) | 37 | 48 |
| Torque increase after | 3 Nm | 3 Nm |
| Curatives | | |

### EXAMPLE 5

The below samples were prepared to demonstrate the ability to make a crosslinked thermoplastic vulcanizate based on an ethylene polymer. In addition, the properties were compared against an ethylene polymer based thermoplastic vulcanizate and a propylene polymer based thermoplastic vulcanizate wherein the ethylene polymer and the propylene polymer were not crosslinked. For instance, samples 16 and 18 demonstrate an ethylene polymer based thermoplastic vulcanizate and a propylene polymer based thermoplastic vulcanizate, respectively, wherein the ethylene polymer and the propylene polymer, respectively, in the thermoplastic phase did not undergo a crosslinking. Meanwhile, sample 17 demonstrates the thermoplastic vulcanizate of sample 16 undergoing a further crosslinking step to crosslink the ethylene polymer.

| Sample | 16 | 17 |
|---|---|---|
| Material Name | phr | phr |
| EPDM 1 | 175.00 | 175.00 |
| LLDPE (0.5 MI; ethylene 1- | 30.00 | 30.00 |
| hexene copolymer) | | |
| Group II paraffinic oil | 5.00 | 5.00 |
| (paraffinic process oil) | | |
| Phenolic resin | 6.30 | 6.30 |
| ZnO | 1.50 | 1.50 |
| Clay | 10.00 | 10.00 |
| 2-Methyl-4,6-bis[(n- | — | 4.60 |
| octylthio)methyl]phenol | | |
| 2,5-Bis(tert-butylperoxy)-2,5- | — | 0.70 |
| dimethylhexane on silica | | |
| Total phr | 227.8 | 233.1 |
| Hardness (Shore A) | 38 | 41 |
| UTS (MPa) | 4.21 | 5.5 |
| UE (%) | 545 | 730 |
| M100 (MPa) | 1.19 | 1.1 |
| Specific Gravity (g/cm³) | 0.90 | 0.90 |

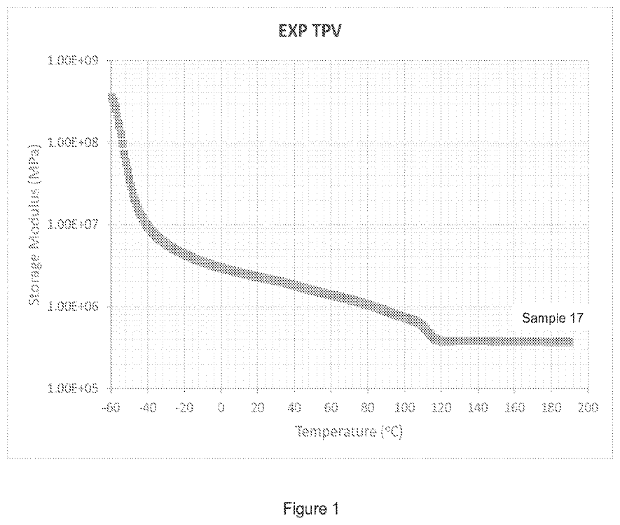

As can be observed, the hardness and ultimate tensile strength increased between samples 16 and 17 due to the crossiinking. In addition, without intended to be limited, the elongation may have increased due to potential elongation of the rubber phase. Meanwhile, the 100% modulus was comparable. In this regard, FIG. 1 illustrates results of a Dynamic Mechanical Thermal Analysis (DMTA) of samples 17 and 18, which demonstrates thermal stability of the crosslinked thermoplastic vulcanizate at temperatures greater than the melting temperature of the ethylene polymer.

### EXAMPLE 6

The below sample was prepared to demonstrate the ability to make a crosslinked thermoplastic vulcanizate based on an ethylene polymer wherein the components of the formulation, including the ethylene polymer, the elastomer, the curing agent, and the crosslinking agent, are provided for making the crosslinked thermoplastic vulcanizate in one process rather than a two-step process. In the sample below, peroxide was utilized as the curing agent and the crosslinking agent.

| Sample | 18 |
|---|---|
| Material Name | phr |
| LLDPE (0.5 MI; ethylene 1- | 40.00 |
| hexene copolymer) | |
| Group II paraffinic oil | 55.00 |
| (paraffinic process oil) | |
| ZnO | 1.50 |
| Clay | 10.00 |
| 2,5-Bis(tert-butylperoxy)-2,5- | 9.00 |
| dimethylhexane on silica | |
| EPDM 4 | 100.00 |
| Total phr | 269.49 |
| Hardness (Shore A) | 70.0 |
| UTS (MPa) | 4.5 |
| UE (%) | 202 |
| M100 (MPa) | 3.2 |

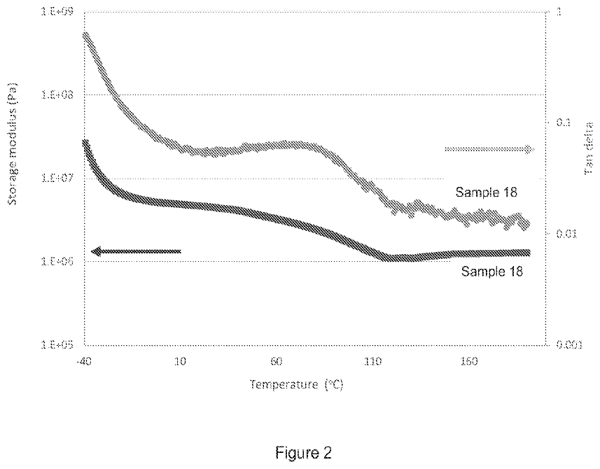

As can be observed in FIG. 2, Dynamic Mechanical Thermal Analysis (DMTA) of sample 18 was conducted and compared with a commercial propylene polymer based thermoplastic vulcanizate. As illustrated, FIG. 2 demonstrates thermal stability of the crosslinked thermoplastic vulcanizate at temperatures greater than the melting temperature of the ethylene polymer.

These and other modifications and variations of the present disclosure may be practiced by those of ordinary skill in the art, without departing from the spirit and scope of the present disclosure. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

1-79. (canceled)

80. A molded article comprising a crosslinked thermoplastic vulcanizate comprising a crosslinked ethylene polymer and an at least partially cured elastomer.

81. The molded article according to claim 80, wherein the crosslinked ethylene polymer is formed from an ethylene copolymer formed from ethylene and a C3-C8 alpha-olefin and/or wherein the elastomer comprises an ethylene/propylene/non-conjugated diene copolymer rubber (EPDM).

82. The molded article according to claim 80, wherein the crosslinked thermoplastic vulcanizate comprises from about 10 wt. % to about 90 wt. % of the at least partially cured elastomer and from about 10 wt. % to about 90 wt. % of the crosslinked ethylene polymer wherein the wt. % is based on the weight of the crosslinked thermoplastic vulcanizate.

83. The molded article according to claim 80, wherein the crosslinked thermoplastic vulcanizate exhibits a Shore A hardness (ISO 868:2003) of from 25 to 100, a 100% modulus of from 0.3 MPa to 50 MPa as determined in accordance with ASTM D412-16, a tensile stress at break of from 0.5 MPa to 100 MPa as determined in accordance with ASTM D412-16, and/or an elongation at break of from 20% to 2000% as determined in accordance with ASTM D412-16.

84. The molded article according to claim 80, wherein the molded article is a wire jacket or a cable jacket.

85. A wire comprising the molded article according to claim 80 and one or more of a shielding, a wrapping, a conductor insulation, and a conductor.

86. A cable comprising the molded article according to claim 80 and one or more of a shielding, a wrapping, a conductor insulation, and a conductor.

87. A method of forming the molded article according to claim 80, the method comprising:
blending a crosslinking agent and a crosslinkable thermoplastic vulcanizate comprising a crosslinkable ethylene polymer and the at least partially cured elastomer to form a first blend;
forming the first blend into a shape of the molded article; and
crosslinking the crosslinkable ethylene polymer to provide the crosslinked ethylene polymer and the crosslinked thermoplastic vulcanizate.

88. The method according to claim 87, wherein the crosslinking agent comprises a peroxide or a silane compound.

89. A method of forming the molded article according to claim 80, the method comprising:
forming a crosslinkable thermoplastic vulcanizate comprising a crosslinkable ethylene polymer and the at least partially cured elastomer into a shape of the molded article; and
crosslinking the crosslinkable ethylene polymer by exposure to irradiation to provide the crosslinked ethylene polymer and the crosslinked thermoplastic vulcanizate.

90. A method of forming the molded article according to claim 80, the method comprising:
providing a thermoplastic vulcanizate formulation comprising a crosslinkable ethylene polymer, an elastomer, a curing agent, and a crosslinking agent;
dynamically vulcanizing the elastomer using the curing agent to form a crosslinkable thermoplastic vulcanizate;
forming the crosslinkable thermoplastic vulcanizate into a shape of the molded article; and
crosslinking the crosslinkable ethylene polymer to provide the crosslinked ethylene polymer and the crosslinked thermoplastic vulcanizate.

91. A method of forming the molded article according to claim 80, the method comprising:
providing a thermoplastic vulcanizate formulation comprising a crosslinkable ethylene polymer, an elastomer, and a curing agent;
dynamically vulcanizing the elastomer using the curing agent to form a crosslinkable thermoplastic vulcanizate;
forming the crosslinkable thermoplastic vulcanizate into a shape of the molded article; and
crosslinking the crosslinkable ethylene polymer by exposure to irradiation to provide the crosslinked ethylene polymer and the crosslinked thermoplastic vulcanizate.

92. A crosslinkable thermoplastic vulcanizate comprising a crosslinkable ethylene polymer and an at least partially cured elastomer, wherein the crosslinkable ethylene polymer has at least 50 mol. % ethylene and from 0 to less than 20 mol. % propylene and is present in an amount of 15 wt. % or more to 60 wt. % or less based on the combined weight of the crosslinkable ethylene polymer and the at least partially cured elastomer and wherein the crosslinkable thermoplastic vulcanizate comprises 5 wt. % or less to 0 wt. % of a propylene polymer based on the weight of the crosslinkable thermoplastic vulcanizate wherein the propylene polymer includes 60 mol. % or more of propylene units.

93. The crosslinkable thermoplastic vulcanizate according to claim 92, wherein the crosslinkable ethylene polymer is an ethylene copolymer formed from ethylene and a C3-C8 alpha-olefin and/or wherein the elastomer comprises an ethylene/propylene/non-conjugated diene copolymer rubber (EPDM).

94. The crosslinkable thermoplastic vulcanizate according to claim 92, further comprising a crosslinking agent.

95. The crosslinkable thermoplastic vulcanizate according to claim 92, wherein the crosslinkable thermoplastic vulcanizate exhibits a Shore A hardness (ISO 868:2003) of from 25 to 100, a 100% modulus of from 0.3 MPa to 50 MPa as determined in accordance with ASTM D412-16ISO, a tensile stress at break of from 0.5 MPa to 100 MPa as determined in accordance with ASTM D412-16, and/or an elongation at break of from 20% to 2000% as determined in accordance with ASTM D412-16.

96. A crosslinked thermoplastic vulcanizate comprising a crosslinked ethylene polymer and an at least partially cured elastomer, wherein the crosslinked ethylene polymer is formed from an ethylene polymer having at least 50 mol. % ethylene and from 0 to less than 20 mol. % propylene.

97. The crosslinked thermoplastic vulcanizate according to claim 96, wherein the crosslinked ethylene polymer is present in an amount of 15 wt. % or more to 60 wt. % or less based on the combined weight of the crosslinked ethylene polymer and the at least partially cured elastomer.

98. The crosslinked thermoplastic vulcanizate according to claim 96, wherein the crosslinked ethylene polymer is formed from an ethylene copolymer formed from ethylene and a C3-C8 alpha-olefin and/or wherein the elastomer comprises an ethylene/propylene/non-conjugated diene copolymer rubber (EPDM).

99. The crosslinked thermoplastic vulcanizate according to claim 96, wherein the crosslinked thermoplastic vulcanizate exhibits a Shore A hardness (ISO 868:2003) of from 25 to 100, a 100% modulus of from 0.3 MPa to 50 MPa as determined in accordance with ASTM D412-16ISO, a tensile stress at break of from 0.5 MPa to 100 as determined in accordance with ASTM D412-16, and/or an elongation at break of from 20% to 2000% as determined in accordance with ASTM D412-16.
